(19) United States
(12) Patent Application Publication
(10) Pub. No.: US 2025/0101308 A1
(43) Pub. Date: Mar. 27, 2025

(54) Solvent-Free Kraft Lignin and Silsesquioxane Modification for Water-Based Superhydrophobic Wood Coating

(71) Applicant: Lakehead University, Thunder Bay (CA)

(72) Inventors: Banchamlak Kassaun, Thunder Bay (CA); Pedram Fatehi, Thunder Bay (CA)

(21) Appl. No.: 18/887,738

(22) Filed: Sep. 17, 2024

Related U.S. Application Data
(60) Provisional application No. 63/584,688, filed on Sep. 22, 2023.

(51) Int. Cl. C09K 21/14; C08H 7/00

(52) U.S. Cl. CPC C09K 21/14; C08H 6/00

(57) ABSTRACT

A novel superhydrophobic sustainable coating material was fabricated from kraft lignin polymerized with silsesquioxane through polycondensation reaction. The reaction under the conditions of pH 11, 60° C., and 48 hours, and a 1:1.2 mmol ratio of SKL/WAPMSS were found to be the optimum for obtaining the polymer, WSL10 with higher Si content. During powder wettability investigation, the optimised sample demonstrated a superhydrophobicity with null mass gain. This characteristic of the copolymer is due to low surface energy and spherical molecule shape, which was the result of an abundance of Si—O—C/Si—O—Si bonds.

### PRIOR APPLICATION INFORMATION

The instant application claims the benefit of US Provisional Patent Application U.S. 63/584,688, filed Sep. 22, 2023, entitled “SOLVENT-FREE KRAFT LIGNIN AND SILSESQUIOXANE MODIFICATION FOR WATER-BASED SUPERHYDROPHOBIC WOOD COATING”, the entire contents of which are hereby incorporated herein by reference for all purposes.

### BACKGROUND OF THE INVENTION

Wood is a renewable resource used in the construction industry, home furnishings, and paper production. It is appreciated for its strength, flexibility, and low specific density [1]. Wood is a valuable alternative to mineral and petroleum products since it requires less energy to process and stores carbon dioxide [2, 3]. However, its hygroscopic and compostable nature affects its dimensional stability and durability [4]. To preserve the wood's inherent ability to wick moisture, there is a growing interest in developing superhydrophobic coatings for wood surfaces [5-7].

Superhydrophobicity is a phenomenon defined by a water contact angle (WCA) higher than 150° and a sliding angle (SA) of less than 10° [8-10]. Superhydrophobicity can be achieved by combining micro/nano-scale surface structure with low surface energy molecules [11-13]. However, the presence of fluorinated compounds, as superhydrophobic materials, known to cause bioaccumulation, and the usage of volatile organic compounds (VOCs) to disperse low surface energy materials have limited the practical applications of these surfaces. Thus, there are strong incentives to fabricate sustainable superhydrophobic coating materials.

Biomaterials, such as wax [14-17] and fatty acids [18-21], have been investigated as inexpensive and environmentally friendly superhydrophobic coating materials for many applications including wood coating. However, limited availability and low resistance to mechanical abrasion limit the applications of these materials as superhydrophobic wood coatings.

Several publications discuss coating formulas containing cellulose derivatives, micro/nano cellulose fibrils, and cellulose nanoparticles [22-24]. A superhydrophobic coating emulsion was prepared by Bayer et al. via combining cellulose nitrate with Fluro acrylic polymer. The superhydrophobicity of WCA>150° was observed on spray-casted aluminium substrate with the coating emulsion [25]. In addition, Huang et al. produced superhydrophobic coatings in wood and glass surfaces with the WCA of 163° by blending cyclosiloxanes, silica particles, zinc oxide, and cellulose nanocrystals with Fluro acrylic polymer [26]. Even though cellulose is a plentiful biomaterial, a significant barrier is the amount of fluoride needed to impact superhydrophobicity to it. The inclusion of lignin, which possesses a hydrophobic tail, was observed to have a synergistic effect in promoting the superhydrophobicity of cellulose based coating formulas [27, 28]. This research shows the advantage of creating lignin based superhydrophobic coating formulations.

Kraft lignin can be applied to wood as a coating substrate to increase fungus resistance and reduce water absorption [29]. However, the chemical modification of lignin is necessary to improve its structural variability, hydrophobicity, and flame retardancy. Modifications, such as methylation, demethylation, phenylation, esterification, and silanization, are among the modification reported to improve lignin hydrophobicity [30-34]. The modification of lignin was made in a two-step process by Hua et al. via hydroxyethylation and esterification. The hydrophobicity of wood was enhanced with a contact angle of 120° after coating with a long aliphatic chain (12C) of dodecanoyl chloride in the structure of lignin [30]. Even though the modification enhanced the hydrophobicity of the lignin-based coating, the two-step modification may not be cost effective [32-34]. In a separate piece of research, in-situ polymerization with urea-formaldehyde pre-polymer was used to effectively encapsulate lignin and safflower oil. Lignin nano capsules were further functionalized by the process of amino silanization. Lignin loadings improved corrosion rates of mild steel, and improved self-healing properties [34]. However, formaldehyde is reported to cause a serious health issue and its use is not recommended [35]. Therefore, it may not be the best choice to produce lignin-based coating formulations. In another study, Kim et al. reported the silanization of softwood kraft lignin with (3-aminopropyl) triethoxysilane (APTES) in a toluene medium and the product generated was used as a dye adsorbent for wastewater treatment. The hydroxyl functional group in the structure of lignin attack and displace the alkoxy groups on the silane or undergo polycondensation [36] with the hydrolyzed OH present in the silane structure. In both instances, a Si—O—C covalent connection was formed [37]. Even though silanization enhanced the thermal properties of kraft lignin, its effect on its hydrophobic properties is unknown and has not been reported, and the use of the powerful solvent toluene in the hydrolysis of alkoxysilane reagent makes this unfavorable. Lignin-based superhydrophobic and flame-retardant coating in the presence of fluorine-free alkoxysilane compounds has yet to be reported.

Wood products deteriorate and burn when exposed to fire or high-intensity heat, leaving them unsuitable for high-temperature applications [38]. To boost the usefulness of wood, its flammability must be improved. Based on their cost-effectiveness and practicality, organic and inorganic compounds, such as nitrogen- and halogen-based coatings, were deemed to be viable for use on the surface of wood. Toxic organic and inorganic methods include nitrogen-based flame retardants and halogenated flame retardants [39]. Hence, it has become necessary to seek out more ecologically friendly flame retardant (FR) coatings, such as nanocellulose, and lignin. The utilization of bio-based flame retardant coatings will aid in reducing carbon footprints [40]. Furthermore, bio-based flame retardants are far more effective than conventional FRs in preventing and reducing the spread of fires [41].

In addition to its abundance and low cost, lignin's aromatic composition and strong charring capacity make it an ideal material for FR coatings [42]. Utilizing its high char-forming capability and abundant hydroxyl groups available for chemical modification, lignin has been investigated as a flame retardant (FR) for various polymer matrices, including low-density polyethylene(LDPE), polypropylene (PP), polylactic acid (PLA), acrylonitrile-butadiene-styrene copolymer (ABS), polyurethane (PU), and epoxy resins (EPs) [42, 43]. Although unmodified lignin can provide a degree of flame retardancy to some polymers, the resultant polymer/lignin composites frequently fail to compete with traditional FRs. Improvement of lignin's FR performance by, chemical modification of lignin with nitrogen and/or phosphorus-containing compounds and nanosizing to prevent lignin aggregation in matrices enhance lignin's FR performance was done; [44, 45]. however, significant hydrophilicity resulting from those modifications hinders the application of lignin-based FR coating for wood. Therefore, the demand for lignin based superhydrophobic as well as flame retardant coating ingredients is in high demand.

### SUMMARY OF THE INVENTION

According to a first aspect of the invention, there is provided a method of preparing a copolymer comprising: mixing about 1 part softwood kraft lignin with about 0.4 to about 2.3 parts aminopropyl/methyl silsesquioxane (mol/mol) in water at a temperature of below about 80 C at a pH of about 10 to about 12 for at least 24 hours; and recovering the softwood kraft lignin-aminopropyl/methyl silsequioxane copolymer.

As used herein, “about” refers to the base number plus or minus 10%. As such, “80 C” refers to “72 C to 88 C”, for example.

In some embodiments of the invention, the pH of the reaction is about 11.

In some embodiments of the invention, the reaction is carried out under aqueous conditions.

In some embodiments of the invention, the ratio is about 1 to about 1.2 or about 1 to about 1.1.

In some embodiments of the invention, the ratio is 1:1.1 or 1:1.2.

In some embodiments of the invention, the temperature is about 40 C to about 80 C.

In some embodiments of the invention, the temperature is about 60 C.

In some embodiments of the invention, the reaction is carried out for about 24 to about 72 hours.

In some embodiments of the invention, the reaction is carried out for about 48 hours.

According to another aspect of the invention, there is provided a flame retardant composition comprising about one part softwood kraft lignin-aminopropyl/methyl silsequioxane copolymer as described above and about 0.25 to 2.0 parts suitable binder.

In some embodiments of the invention, the flame retardant composition comprises about one part softwood kraft lignin-aminopropyl/methyl silsequioxane copolymer and about one part suitable binder.

According to another aspect of the invention, there is provided a softwood kraft lignin-aminopropyl/methyl silsequioxane copolymer prepared as described above.

As will be apparent to those of skill in the art, the binder's purpose is to transport the hydrophobic and flame-retardant composition to the surface of the article to be coated and ensure excellent adhesion with that surface. As such, a suitable binder allows for the copolymer to be disseminated in the binder system while not altering or diminishing the hydrophobic and flame retardant properties of the copolymer.

In some embodiments of the invention, the binder is selected from the group consisting of but by no means limited to a water-soluble inorganic aluminum phosphate binder, a polyurethane binder, an epoxy binder and other similar suitable binders.

According to another aspect of the invention, there is provided a method of preparing a flame retardant composition comprising: mixing about 1 part softwood kraft lignin with about 0.4 to about 2.3 parts aminopropyl/methyl silsesquioxane in water at a temperature of below about 80 C at a pH of about 10 to about 12 for at least 24 hours; recovering the softwood kraft lignin-aminopropyl/methyl silsequioxane copolymer; and mixing about one part copolymer as described above and about 0.25 to 2.0 parts suitable binder, thereby producing the flame retardant composition.

According to another aspect of the invention, there is provided a wood article coated with the flame retardant composition as described above or as prepared according to the method as described above.

### BRIEF DESCRIPTION OF THE DRAWINGS

FIG. 1. a)¹HNMR spectra for SKL, WAPMSS oligomer, and copolymers; b) Structure of WSL copolymers.

FIG. 2. HSQC spectra δ_{C}/δ_{H 10}-145/-2-8 of SKL (a), WAPMSS (b), WSL2 (c), WSL 5 (d), WSL 6 (e), and WSL 10 (f).

FIG. 3. ³¹P-NMR (a), FTIR spectra analysis (b), XPS C1s deconvoluted spectra (c) of SKL, WAPMSS, and WSL copolymers and (d) XPS Si 2p deconvoluted spectra of WSL copolymers (c), The concentrations indicated are in FIG. 3a is in mmol/g.

FIG. 4. C1s deconvoluted spectra for SKL (a), WAPMSS (b), WSL2 (c), WSL5 (d), WSL-6 (e) and WSL10 (f).

FIG. 5. Si 2p deconvoluted spectra for WSL-2 (a), WSL-5 (b), WSL-6 (c), and WSL10 (d).

FIG. 6. Powder wettability analysis for SKL, WSL2, WSL6, WSL5, and WSL10.

FIG. 7. Water absorption of SKL and WSL copolymers (a) TGA curve showing Tₒ and T_{50 %} (b), DTG curve indicating DTGₘₐₓ (c) and T_{g} on the DSC curve (d) of SKL and WSL copolymers, and TSI variation of coating formulations over 6 h (legends indicate the wt. ratio) (e).

FIG. 8: TSI values of 6 hours 30 second scan for all the formulations variation of coating formulations for 6 h (legends indicate the wt. gram ratio of WSL 10 to AP).

FIG. 9. (a), (b) SEM image and (c) water contact angle of uncoated wood, (d), (e) SEM image and (f) water contact angle of AP coated wood, (g), (h) SEM image and (i) water contact angle of SKL-AP (1/1 wt. gram ratio of SKL and AP) coated wood, and (J), (k) SEM image and (1) water contact angle of WSL-AP (1/1 wt. gram ratio of WSL and AP) coated wood FIG. 10. Water contact angle analysis for different ratio of WSL 10 and AP (a), contact angle analysis for different chemicals (b), droplets of different solutions deposited on wood surface coated with WSL 10 and AP 1/1 wt. ratio (c), adhesion force measurement (d) and water droplet adhesion analysis image of WSL 10-AP (e).

FIG. 11. Limited oxygen index (LOI) values (a), light absorption (b), images samples after smoke density analysis (c), smoke density rating values (d) of Uncoated wood, AP coated, SKL-AP and WSL 10-AP (1/1 wt. ratio of WSL/SKL to AP).

FIG. 12. Limiting oxygen index (LOI) (a), light absorption (b), smoke density rating values (c), and images of the flame test for uncoated wood (d), AP-coated (e), SKL-AP (f), and WSL10-AP (1/1 wt./wt.) (g).

### DESCRIPTION OF THE PREFERRED EMBODIMENTS

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are now described. All publications mentioned hereunder are incorporated herein by reference.

In this study, we demonstrate, for the first time, a solvent-free copolymerization of softwood kraft lignin (SKL) with aminopropyl/methyl silsesquioxane (WAPMSS) to generate an ingredient of sustainable coating formula with elevated thermal stability and superhydrophobic features for wood products. To increase the dispersion and adherence of the copolymer, a water-soluble inorganic aluminium phosphate (AP) binder was utilised. The physicochemical, surface, and thermal characteristics of coating formulas were comprehensively investigated by advanced techniques such as NMR, XPS, TGA, contact angle, limited oxygen index and smoke detector. This research demonstrates that silsesquioxane-copolymerized lignin can be used to provide fluorine-free aqueous coating formulations for superhydrophobic and flame-retardant surfaces with impressive performance.

There is a tremendous motivation to develop eco-friendly formulas for superhydrophobic coatings. Currently used materials, particularly fluorinated compounds, and intense organic solvents, are potentially hazardous. Here, we demonstrate that a silsesquioxane-grafted softwood kraft lignin (WSL) aqueous dispersion in an aluminum phosphate (AP) binder, i.e., a new sustainable green formulation, can produce a superhydrophobic coating that is extremely resistant to water and devoid of solvents and fluorine. The chemical reaction of softwood kraft lignin (SKL) and aminopropyl/methyl silsesquioxane (WAPMSS) oligomer was studied in detail. NMR and XPS analyses confirmed the conversion of reactive hydroxyl groups of SKL to Si—O—C via polycondensation. By exchanging hydrophilic hydroxyl groups with Si—O—C and Si—O—C groups, the resulting powder exhibited negligible wettability and was very hydrophobic. Dip coatings of stain-grade pine wood with a WSL10 and AP dispersion in a 1/1 wt./wt. gram ratio exhibited superhydrophobicity with a water contact angle of (WCA)=157° and flame-retardancy with a limited oxygen index (LOI) of 27.2%. The formation of crosslinked silsesquioxane structure in the backbone of lignin's aromatic rings is responsible for the coating's enhanced superhydrophobic and flame-retardant mechanism.

This novel superhydrophobic sustainable coating material was fabricated from kraft lignin polymerized with silsesquioxane through polycondensation reaction. The reaction was modeled via Taguchi L9 4×3 and optimized for grafting ratios. The reaction under the conditions of pH 11, 60° C., and 48 hours, and a 1:1.2 mmol ratio of SKL/WAPMSS were found to be the optimum for obtaining the polymer, WSL10, with higher Si content. NMR, XPS, and FTIR measurements validated the success of copolymerization for the presence of Si—O—C/Si—O—Si bonds. DSC and TGA revealed an increase in the thermal stability and T_{g} of the material ascribable to the abundance of aromatic ring from lignin to the copolymer, an increase in the molecular weight after polymerization, and a more rigid structure due to the presence of the inorganic phase, which partially inhibited macromolecular movement. During powder wettability investigation, the optimised sample (WSL10) demonstrated superhydrophobicity with null mass gain. This characteristic of the copolymer is due to low surface energy and spherical molecule shape, which was the result of an abundance of Si—O—C/Si—O—Si bonds. In the water-based synthesis of AP binder-based coatings, the optimised sample WSL10 was used as the major component. In line with the Turbiscan stability index, the addition of AP binder to the formulation of the coating enhances the stability of the suspension while hydrophobic properties of the formulation improve with the addition of WSL10. According to the static contact angle analysis, a 1:1 weight ratio of WSL 10 and AP binder had a greater contact angle than a similar weight ratio of AP binder alone and SKL-AP binder formulations. When WSL10 was included in the formulation, the water sliding angle was around 4, and only 0.05 mN pull off force was required for removing the water droplet from the surface, which confirmed the superhydrophobicity of the coating. The LOI value of 27% and the SDR of 15% indicated the flame-retardant characteristics of the WSL10 coatings. The result of this study reveals that lignin can be utilised as a renewable precursor in the production of high-value functional coatings. Additionally, the findings highlight that these materials hold in the field of producing superhydrophobic and flame-retardant wood surfaces.

According to an aspect of the invention, there is provided a method of preparing a copolymer comprising: mixing about 1 part softwood kraft lignin with about 0.4 to about 2.3 parts aminopropyl/methyl silsesquioxane (mol/mol) in water at a temperature of below about 80 C at a pH of about 10 to about 12 for at least 24 hours; and recovering the softwood kraft lignin-aminopropyl/methyl silsequioxane copolymer.

As used herein, “about” refers to the base number plus or minus 10%. As such, “80 C” refers to “72 C to 88 C”, for example.

In some embodiments of the invention, the pH of the reaction is about 11.

In some embodiments of the invention, the reaction is carried out under aqueous conditions.

In some embodiments of the invention, the ratio is about 1 to about 1.2 or about 1 to about 1.1.

In some embodiments of the invention, the ratio is 1:1.1 or 1:1.2.

In some embodiments of the invention, the temperature is about 40 C to about 80 C.

In some embodiments of the invention, the temperature is about 60 C.

In some embodiments of the invention, the reaction is carried out for about 24 to about 72 hours.

In some embodiments of the invention, the reaction is carried out for about 48 hours.

According to another aspect of the invention, there is provided a flame retardant composition comprising about one part softwood kraft lignin-aminopropyl/methyl silsequioxane copolymer as described above and about 0.25 to 2.0 parts suitable binder.

In some embodiments of the invention, the flame retardant composition comprises about one part softwood kraft lignin-aminopropyl/methyl silsequioxane copolymer and about one part suitable binder.

According to another aspect of the invention, there is provided a softwood kraft lignin-aminopropyl/methyl silsequioxane copolymer prepared as described above.

As will be apparent to those of skill in the art, the binder's purpose is to transport the hydrophobic and flame-retardant composition to the surface of the article to be coated and ensure excellent adhesion with that surface. As such, a suitable binder allows for the copolymer to be disseminated in the binder system while not altering or diminishing the hydrophobic and flame retardant properties of the copolymer.

In some embodiments of the invention, the binder is selected from the group consisting of but by no means limited to a water-soluble inorganic aluminum phosphate binder, a polyurethane binder, an epoxy binder and other similar suitable binders.

According to another aspect of the invention, there is provided a method of preparing a flame retardant composition comprising: mixing about 1 part softwood kraft lignin with about 0.4 to about 2.3 parts aminopropyl/methyl silsesquioxane in water at a temperature of below about 80 C at a pH of about 10 to about 12 for at least 24 hours; recovering the softwood kraft lignin-aminopropyl/methyl silsequioxane copolymer; and mixing about one part copolymer as described above and about 0.25 to 2.0 parts suitable binder, thereby producing the flame retardant composition. A wood article coated with the flame retardant composition as described above or as prepared according to the method as described above.

The invention will now be further explained and/or elucidated by way of examples; however, the invention is not necessarily limited to or by the examples.

### Example 1—Reaction Optimization of SKL and WAPMSS

SKL is rich in hydroxyl group, the most active sites in its structure are aliphatic and phenolic hydroxyl groups, which are the primary sites of lignin modification [67]. In this reaction, an OH is lost from the silanol (—Si—OH) group of WAPMSS along with hydrogen from phenolic/aliphatic hydroxyl groups of SKL leaving the two reactants linked via Si—O—C bond. To identify the best reaction condition, Taguchi L9 4×3 orthogonal array was utilized as shown in Table 1. Four factors, i.e., WAPMSS concentration, pH, temperature, and time with three levels were considered for each factor. The reaction percent yield and grafting ratio were determined for all copolymers as described in Equations S1 and S2 and results are presented in Table 2. An increase in the concentration of WAPMSS, pH and time resulted in a higher grafting of WAPMSS to SKL. Concentrating WAPMSS may have boosted the grafting ratio because, once the hydroxyl groups of SKL are silanated utilizing WAPMSS molecules, the remaining silanol groups would react with nearby WAPMSS molecules, forming a multilayer WAPMSS crosslinked molecular layer on SKL backbone [32]. Another factor is pH: at higher pH, the phenolic and aliphatic hydroxyl groups of SKL are more likely to deprotonate, making SKL more reactive [68]. Therefore, the silanol groups of WAPMSS can bind with SKL easily and quickly. On the other hand, a higher temperature (80° C.) had a detrimental effect on the grafting ratio. This may be due to the tendency for SKL to undergo self-polymerization at higher reaction temperature [69], which makes it difficult for the WAPMSS silanol group to react with SKL. Based on this analysis, the reaction conditions of (1/1.1 molar ratio of SKL/WAPMSS), pH 11, 60° C. and 48 h were determined to be the optimal for generating copolymer of WSL 10 with the highest yield, 78% and grafting ratio of 140%. The optimized sample (WSL 10) was chosen for further investigation, along with the sample with the lowest grafting ratio (WAL 7), the sample with the highest grafting ratio (WSL 6), and the sample in between (WSL 5) to see how the resulting structural variability would affect the performance of the products.

### Example 2—NMR Characterization

### ¹H-NMR Analysis

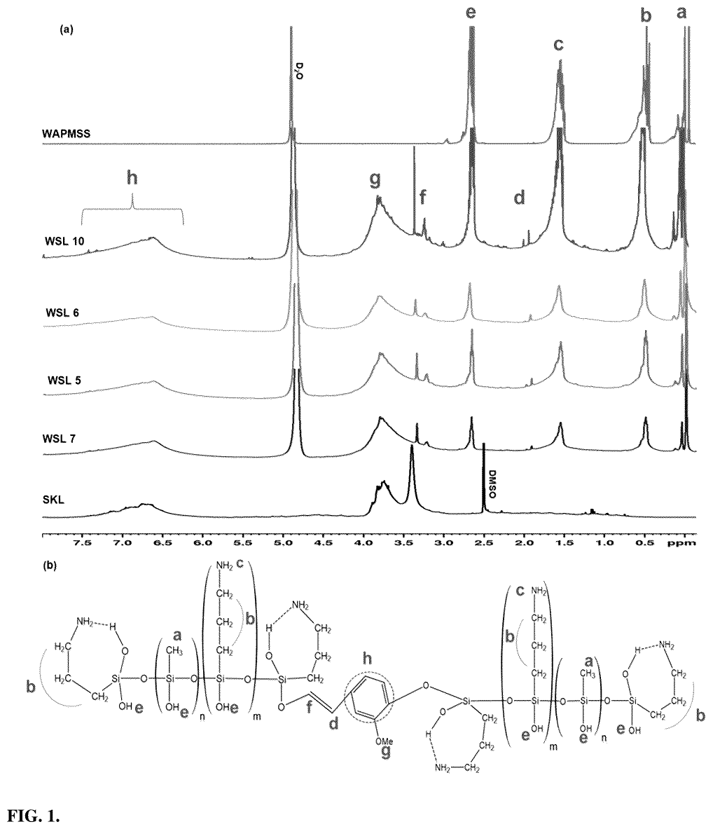

The chemical structures of SKL, WAPMSS, and WSL copolymers were analyzed by NMR. The H-NMR analysis of SKL, WAPMSS, and WSL copolymers is shown in FIG. 1(a) and the structure of the copolymers is depicted FIG. 1(b). The signal corresponding to DMSO-d₆ is observed at 2.5 ppm for SKL. and the signal corresponding to D₂O in the WAPMSS and copolymers spectra is assigned at 5 ppm. In the ¹H spectra of SKL, aromatic protons are characterized by a signal between 6.0 and 7.5 ppm (h), while methoxy protons are in the 3-4 ppm (g) zone. In the area between 0 and 3.2 ppm, aliphatic protons can be detected [70][Z1]. For WAPMSS the strong peaks observed at 2.7 ppm is associated with the —OH peaks (e) linked with Si, signals around 1.5 ppm on the spectra of the copolymers are associated with protons from NH₂ (c) signals at 0.5 ppm are associated with the propyl structure of protons from —CH₂—CH₂—CH₂ (b), very distinctive peaks at 0 ppm are assigned to the proton of CHs linked to Si (a) [72-74].

The ¹H-NMR spectra of the copolymers reveal the inheritance of aromatic (h) and methoxy (g) protons from SKL. Similarly, the signals of a, b, c, and e in the figure are inherited from WAPMSS. However, the appearance and intensity of the signals is different between the copolymers, and WSL10 has the stronger signals of a, b, c, and e among the copolymers. Furthermore, new peaks appearing in the spectra of the copolymer around 1.8-1.9 ppm (d) and 3-3.2 ppm (f) correspond to the new aliphatic linkage created by the condensation of SKL aliphatic OH and WAPMSS OH.

### Example 3—HSQC analysis

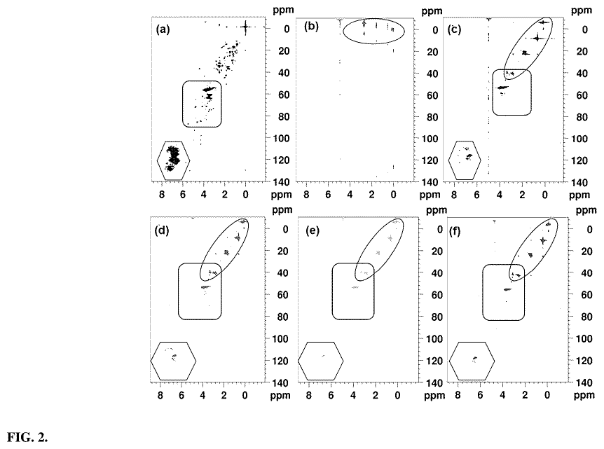

The HSQC NMR analysis of SKL, WAPMSS, and copolymers were performed to indicate major linkage and building block of the samples as shown in FIG. 2. Significant lignin interunit structures, such as aromatic units of SKL (δ_{C}/δ_{H} 110.6-122.9/6.7-7.5 ppm), the C—C aliphatic area (δ_{C}/δ_{H} of 5-50/0.5-3 ppm) and C—O aliphatic area (δ_{C}/δ_{H} of 50-95/2.75-6 ppm), were identified and marked with hexagon, elliptical and rectangular shapes, respectively in FIG. 2(a). The correlation signals of guaiacyl (G) units G₂ (C₂—H₂), G₂′ (C₂—H₂), G₅ (C₅—H₅), G₆ (C₆—H₆), and G₆′ (C₆—H₆) in SKL were observed at 110.6/6.7, 108.8/7.04, 115.9/6.7, 119.1/6.7, and 122.9/7.5, respectively. The prominent interunit linkages in β-O-4 (A_{β}), phenylcoumaranan β-5 (B_{β}) and resinol β-β (C_{β}) were identified for SKL at cross peak signals of δ_{C}/δ_{H} 71.4/4.7 ppm, δ_{C}/δ_{H} of 53.29/3.44 ppm and δ_{C}/δ_{H} of 53.6/3.0 ppm, respectively [75, 76]. Furthermore, the methoxy (—OCH₃) functional group characteristic signal was identified at δ_{C}/δ_{H} of 55.5/3.70. On the other hand, WAPMSS oligomer only have strong aliphatic C—C linkages appearing in the cross-peak signals δ_{C}/δ_{H} of 0-22/0-3.2 in FIG. 2b. The copolymers' HSQC spectra reveal the unambiguous aromatic and methoxy structures in FIG. 2 (c-f). This confirms the copolymers had inherited the aromatic units and methoxy groups from SKL aligning with H-NMR results. The robust aliphatic structures appeared in the copolymer structure is inherited from WAPMSS in FIG. 2 (c-f). As will be apparent to those of skill in the art, this structure is the reason for the improved hydrophobicity and flame retardant and/or fire retardant properties of the material.

Compared with SKL, the copolymer samples had the same intensity of the interunit phenyl coumarans β-β linkage. The β-O-4 and phenylcoumaranan β-5 linkages were detected only for WSL10, while Cα-Hα in phenylcoumaran substructures, Cγ-Hγ in resinol units, and Cγ-Hγ in β-O-4′ were prominent in all except WSL6 sample. It is possible that β-O-4 and β-5 linkages were cleaved due to the higher temperature and prolonged reaction conditions for WSL6. A new cross-peak signal was identified for all the copolymers in the C—O linkages region at δ_{C}/δ_{H} of 46.2/3.21 ppm, which is for the new linkage created by the condensation of WAPMSS and SKL OH.

### Example 4—³¹P NMR

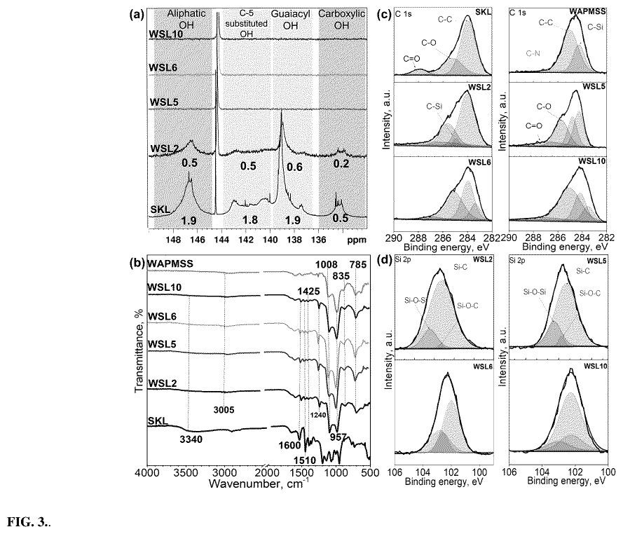

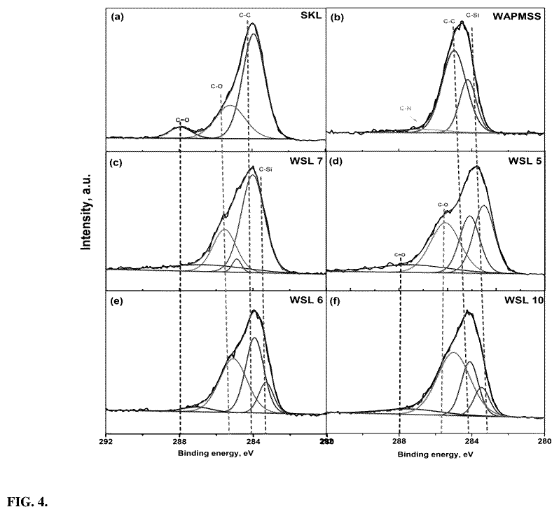

The ³¹P-NMR spectra of SKL, WSL2, WSL6 and WSL5 are displayed in FIG. 3 (a) to quantify the aliphatic, phenolic (C-5 substituted and guaiacyl) and carboxylate OH group content of the samples after phosphorylation [77]. As observed in FIG. 3, the hydroxyl groups of the copolymers were reduced relative to that of SKL. In addition, the contents of aliphatic, total phenolic, and carboxylate OH of SKL were higher than those of WSL2. The proportionate decrease in the concentration of phenolic, aliphatic, and carboxylic groups indicates that the condensation process was not selective.

### Example 5—FTIR Analysis

The FTIR spectra of SKL, WAPMSS oligomer and copolymers are shown in FIG. 3(b). The transmittance at 1600, 1510, and 1425 cm⁻¹ are distinctive peaks of aromatic ring vibrations for SKL [78]. These distinctive peaks are present in copolymers aligning with ¹H NMR and HSQC analyses. The transmittance peak at 3340 cm⁻¹ is attributed to the aliphatic and phenolic OH stretching of SKL [79]. The intensity of this peak is significantly reduced in the copolymer's spectra compared to SKL. This information can be used to support P-NMR results, as it confirms that all OH groups of lignin are occupied due to salinization via polycondensation [32]. The WAPMSS spectra indicates transmittance at 3750 cm⁻¹ corresponding to free silanol (Si—OH) groups in organo silicon compounds [80]. The transmittance at 3005 cm⁻¹ corresponds to sp², which are the contribution of C—H associated with silicon [81]. In addition, the high transmittance at 835 and 785 cm⁻¹ is characteristic of Si—CH₃. The siloxanes (Si—O—Si) have more intense infrared bands between 1008 and 1000 cm⁻¹. The inheritance of mentioned transmittance signals from WAPMSS to the copolymers were detected, aligning with the H-NMR and HSQC analyses. In the copolymer spectra, the strong transmittance signals at 1240 and 975 cm⁻¹ is for phenoxy group attached to silicon [72, 82]. Compared to WSL2, the increased intensity of Si—O—Si and Si—O—C bonds in WSL6 can be attributed to an increase in the WAPMSS concentration. The sample produced under the optimized conditions, WSL10, displayed a relatively high intensity in the Si—O—C bond, which will be further quantified by XPS analysis.

### Example 6—XPS Analysis

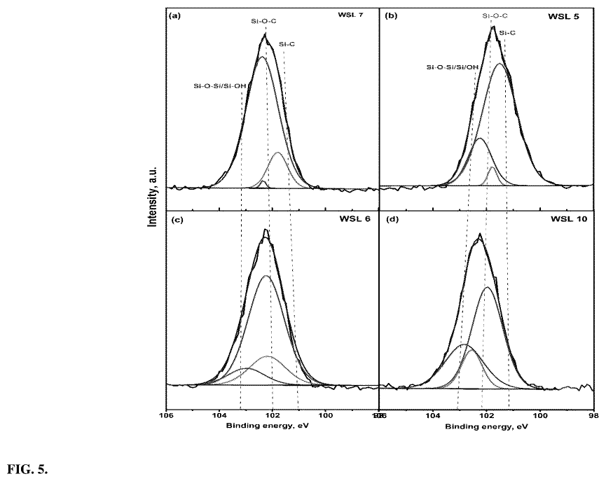

Surface elemental compositions and chemical bonds of SKL, WAPMSS and copolymers were studied by XPS. The elemental compositions of SKL were carbon (285 eV) and oxygen (532 eV) [83]. Additional elements, nitrogen (400 eV) [84] and silicon (152.9 eV and 101 eV) [85] were also detected for the WAPMSS oligomer and for the copolymers in Figure S6a in supplementary materials. The core level spectra of C1s with fitting analysis for the peaks related to carbon linkages are observed in FIG. 4. SKL Cis peak deconvolution resulted in three major components of C—C (284.8 eV), C═O (˜288-290 eV), and C—O (˜286 eV) in FIG. 4a. Likewise, the C1s spectrum of WAPMSS was analyzed, and the major carbon linkages was C—Si (283 eV), C—C(284.8 eV) and traces of C—N(286 eV) [86, 87]. In the copolymers' C1s envelope, the C—C, C—O, C—Si, and traces of C═O linkages were identified in FIG. 4 (c-f). The O═C—O bond concentration decreased significantly for all copolymers compared to SKL, while the O—C bond concentration increased. Between the copolymers, WSL2 had the highest concentration of O═C—O bonds, followed by WSL5 and WSL6, while WSL10 had the lowest concentration. This implies that all the possible OH reactive sites participated in the reaction, which is consistent with P-NMR and FTIR studies. Furthermore, the copolymers had a higher concentration of C—O bonds than SKL. This is due to the formation of a novel Si—O—C linkage between SKL and WAPMSS due to the polycondensation reaction, which is in a good agreement with the HSQC analysis showing an increase in C—O aliphatic linkages.

Similar Si 2p peaks were deconvoluted for WAPMSS and copolymers, and results are presented in FIG. 5 (a-d). The Si 2p spectra for WAPMSS show two deconvoluted components of Si—C(101.34 eV) and Si—O—SVSi—OH (103.76 eV). However, the copolymers showed a third new component of Si—O—C (102.5) [88, 89], which is in good alignment with FTIR analysis. The presence and concentration of Si—O—C linkages confirm the copolymerization of SKL and WAPMSS. From the WSL 7 copolymer, only 10% of the Si concentration is linked to O—C bond. However, the WSL10 structure had 60% of Si presented in the structure linked to the O—C, showing that the optimization helped in creating more Si—O—C linkages, which is in good alignment with FTIR analysis. The detection of these linkages within copolymers is evidence of copolymerisation.

### Example 7—Molecular Weight (MW), Radius of Gyration (R_{g}), and Hydrodynamic Radius (Rh)

The MW, R_{g}, Rₕ, and shape factor, R_{g}/Rₕ, of SKL and the copolymer macromolecules in NaOH solution were analysed with SLS and DLS techniques at 25° C., and the results are presented in Table 3. It is seen that MW, R_{g}, and Rₕ of the copolymers were much greater than those of SKL. The grafting of WAPMSS molecules to the SKL structure resulted in an increase in the MW of the copolymers. After the reaction, there was an obvious increase in the MW of the copolymers compared to SKL. The highest MW was for WSL10, which could be due to the amine group from WAPMSS inducing a side reaction on the lignin backbone, such as a condensation crosslinking reaction, which was confirmed by NMR, FTIR and XPS. WSL2 had the lowest MW, owning to the lowest concentration of WAPMSS and lowest reaction conditions (time, temperature, and pH). The R_{g} and Rh of the copolymer were also higher than those of SKL. In general, the increase in the R_{g} and Rₕ of copolymer can be attributed to the introduction of WAPMSS molecules to the SKL structure, which increased the effective size of the copolymers. As will be apparent to those of skill in the art, the increase in the molecular size of the copolymers relative to unmodified lignin (SKL) confirms the copolymerization. Put another way, polymerization means chain extension and molecular weight analysis is direct evidence and proof of that.

The shape and compactness of polymer aggregates in a solution can further be determined by the shape factor of the polymers, R_{g}/Rₕ, in solution [90]. For anisotropic geometry, Rg/Rh of 1.5-1.8 implies an extended random coil particle, 1.0-1.3 a hyperbranched cluster, 1.0 a hollow sphere (1.0), and 0.77 a uniform sphere (dense centre ornamented by long, sparse chains) [91]. In general, the shape factor of the copolymers was less than that of SKL (˜1.7), which is indicative of the random coil aggregates formed when SKL is dissolved in a strong alkali solution [92]. The smaller shape factor value of the copolymers can be explained by the formation of larger self-assembly characteristics of silsesquioxane-containing molecules in an aqueous environment resulting from the hydrophobic end chains [93]. However, between the copolymers, WSL10 had a shape factor value around ˜0.775, indicating a spherical micelle geometry with a higher density at the center, which can be explained by the crosslinking silsesquioxane molecules on the backbone of SKL [94]. The crosslinking density of silsesquioxane on the backbone of SKL is supported by the higher concentration of Si—O—Si linkage from XPS (FIG. 5d) and FTIR (FIG. 3b) results for WSL10.

### Example 8—Powder Wettability Analysis

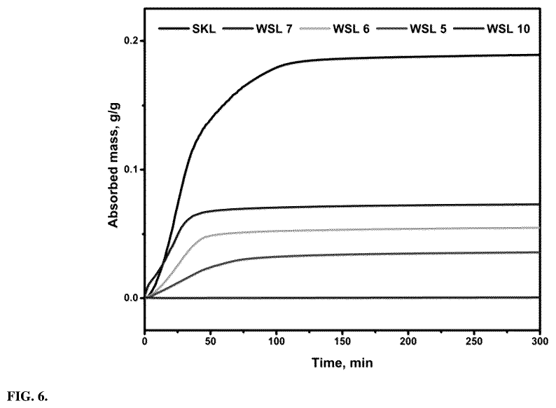

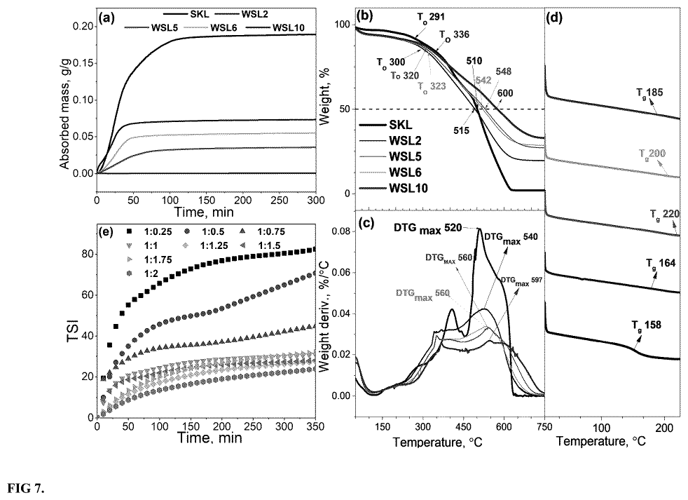

The wetting process involves an exchange of solid/gas particles for solid/water particles. When determining wettability, the Washburn method looks at how liquid can penetrate a powder bed as a function of time. The wettability of SKL and WSL copolymers are shown in FIG. 6. Compared to the copolymers, SKL absorbs water slowly but extensively. Between the copolymers, WSL2 exhibited the highest water uptake in the first 50 min, followed by WSL5 and WSL6 in a descending order. The WSL2's highest water absorption can be justified by the precence of free hydroxyl groups in the structure as discussed in the P-NMR (FIG. 3a) and XPS analyses (FIG. 5c). On the other hand, the WSL5 has less COOH and more Si—C groups in its structure, contributing to its limited water uptake. However, WSL10 showed no sign of water absorption indicating the copolymers having superhydrophobic properties [95]. The superhydrophobicity of the sample originates from its high concentration of Si—O—C and Si—O—Si bonds in the structure of the copolymer, which was confirmed by the XPS (FIG. 3b) and FTIR (FIG. 5d) results [96-98].

### Example 9—Thermal Analysis

The thermal stability of SKL, WSL2, WSL6, WSL5, and WSL10 was investigated by TGA and DSC analyses, and the results are shown in FIG. 7(b-c). The TGA and DTG curves are depicted in FIGS. 7(b) and 7(c), respectively. The onset temperature (Tₒ), the temperature of 50% weight loss (Tso %), and the maximum decomposition temperature (DTGₘₐₓ) were utilized to characterize the thermal sensitivity of the copolymers. SKL displayed a rapid weight loss at approximately 290±2° C. with a 50% weight loss at approximately 500±4° C. Due to the intricacy of lignin biomacromolecules, its complete breakdown occurred between 50° and 520° C. [52]. The copolymers displayed distinctive decomposition behavior compared to SKL in FIGS. 7(b) and 7(c). The decomposition of WSL polymers starts at higher temperatures, at approximately 300° C., and the maximum decomposition occurs at higher than 600° C. The improvement in the decomposition temperature for the copolymers resulted from the condensation or crosslinking reaction of WAPMSS in the SKL macromolecules. In addition, the DTGₘₐₓ of WSL10 was 120° larger than that of SKL, and the char residue of WSL10 was 33% greater than that of SKL. Adding Si to the copolymer's macromolecular structure increases DTGₘₐₓ and weight residue [101]. Differences in Tₒ and DTGₘₐₓ were noticed among the copolymers. The decomposition temperature of WSL2 was lower than that of WSL6, WSL5, and WSL10. An enhanced substitution occurred in a greater quantity of WAPMSS, resulting in a more compact structure (Table 3), which can explain the higher thermal stability of WSL6, WSL5, and WSL10.

To gain a deeper understanding of the structural change caused by temperature on the structure of copolymers, residues obtained at different temperatures of TGA analysis were subjected to XPS analysis. The C—C bond only decreased by 4% from its initial concentration, which indicates that the grafting of WAPMSS safeguards the aromatic rings within the lignin structure up to 420° C. Also, Si detected in the copolymer after 800° C. is linked to the Si—O—C(55%) and Si—O—Si (40%) structures, as confirmed in XPS analysis. Interestingly, the residues of an aromatic ring connected to Si are still detectable after 800° C. in the residual of the samples after TGA analysis. This can be attributed to the formation of a heat shield composed of silicon oxygen network structure that protects the organic structure. As will be appreciated by those of skill in the art, this structure is very important for flame retardancy and The function of the material is directly attributable to its chemical structure as proven above.

The glass transition, T_{g}, behaviors of SKL and copolymers is depicted in FIG. 7 (b). T_{g} is strongly reliant on the molecular structure and crosslinking density of a polymer. In general, the T_{g} of the copolymers was higher than that of SKL. This is a clear indication that the copolymerization of WAPMSS and SKL resulted in a crosslinked structure reducing the free volume of the chains mobility which resulted in an increased T_{g}. The effective improvement in the T_{g} was attributed to the increase in the molecular weight (Table 1) and rigid cage structure of silsesquioxane and the SKL crosslinking network [101]. As the proportion of WAPMSS increased in the copolymer, the T_{g} of the copolymers also increased. While WSL2 has the lowest concentration of WAPMSS, its T_{g} is lower than that of the other copolymers, but WSL6's greater WAPMSS concentration results in a higher T_{g}. This is directly related to the tendency of rigid cage structure of silsesquioxane structure created in the backbone of SKL [102]. The addition of silsesquioxane reduced the mobility of the copolymer chain and enhanced its T_{g} [103]. As known by those of skill in the art, the glass transition temperature is when a polymer transitions from a rigid glassy state to a soft rubbery state. A higher glass transition temperature in our copolymer is: (i) an indication of successful copolymerization since silsesquioxane linkage increases Tg. (ii) It also indicates the copolymers can stand higher temperatures before being soft and tacky, which is another proof of stability at a high temperature.

### Example 10—Coating Formulation Stability

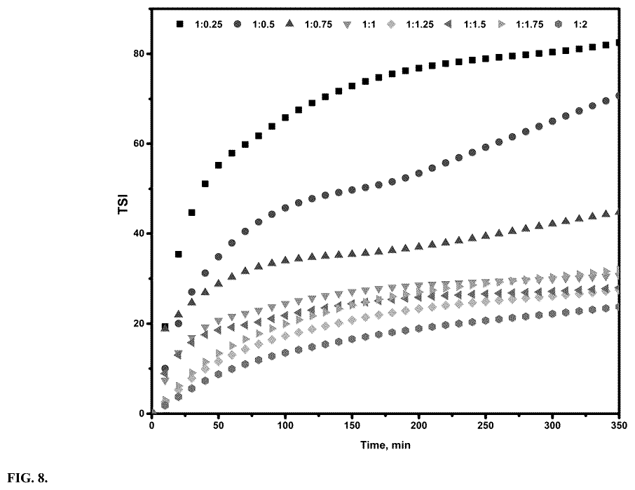

The physical stability of a coating formulation reveals information about the constituents' interactions and shelf life of the formulation [104]. Eight coating formulations were created by mixing WSL10 and AP at different ratios as displayed in Table 4. The physical stability as defined by the TSI global over 6 h of the eight formulations is shown in FIG. 8. The higher the stability of a coating formulation, the lower the TSI value. It was observed that when the amount of WSL10 was higher than AP in the aqueous dispersion, the TSI value dropped, implying the WSL10 particles had higher hydrophobic interaction within themselves leading to agglomeration and settling. Interestingly, the formula containing 50% WSL10 had reasonable TSI value of 24, and further reducing its content did not improve the stability of the suspension remarkably. The AP binder used in the formulation, improved the stability of the WSL10 particles in water to a grater extent. Given that the phosphonate group from AP and available silanol group from WSL10 can create intermolecular hydrogen-bond formation [105, 106].

### Example 11—Surface characterization of coated wood

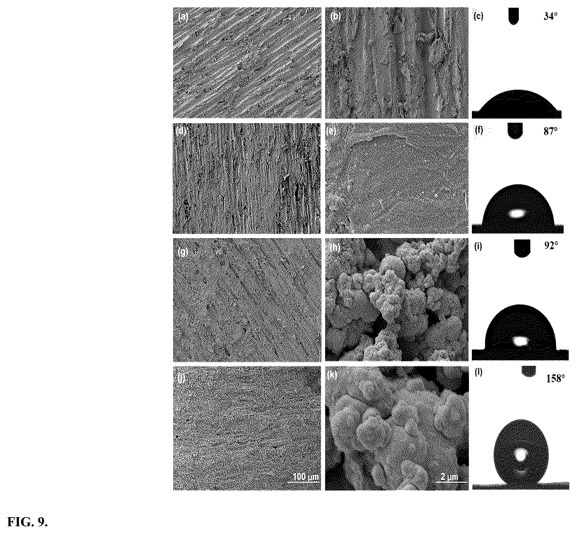

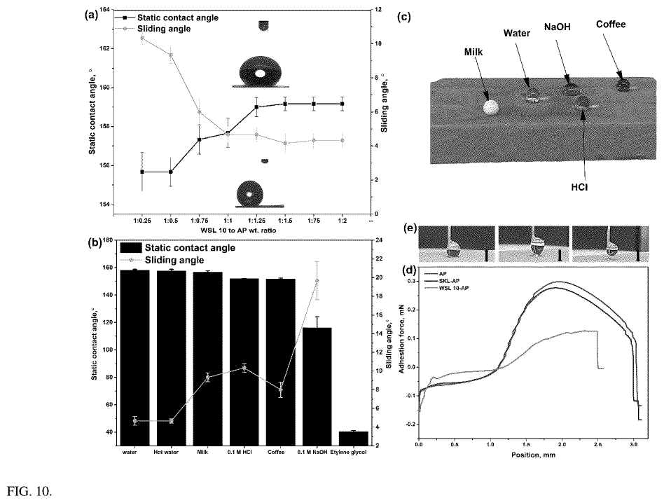

The surface morphology and water contact angle of four samples, comprising uncoated wood, wood coated with AP binder, SKL-AP 1/1 wt. gram ratio and WSL 10-AP 1/1 wt. gram ratio coated wood surface, were evaluated and the findings are shown in FIG. 9. Uncoated wood surface had a relatively smooth surface where the grains, pits, and grooves could be observed, with a hydrophilic property (WCA=34°) as seen in FIG. 9 (c). AP binder coated wood had a rough surface, where the visible grooves and pits were covered, with a water contact angle of 87° (FIGS. 9d, 9e and 9f). This hydrophilic properties of AP binder is the reason for its limited application as a wood coating [107]. When SKL was added to the coating formula, the wood's surface exhibited complex aggregated and agglomerated structures (FIGS. 9g and 9h), and the water contact angle increased to 97° (i). The introduction of rough surface morphology enhanced water repellency of the formulation on the coated surface [108]. Wood surface covered with a formulation containing WSL10 displays more distinct patterns, with spherical large particles connected to smaller particles with a water contact angle of 158° (FIGS. 9j, 9k and 9i). In this case, WSL10 imparted superhydrophobicity to wood surfaces because of its chemical structure, as discussed earlier.

The static contact angle of water droplet on the wood coated with different formulas is shown in FIG. 10a. Evidently, the variation in the ratio of WSL10 and AP did not affect the contact angle significantly, and a contact angle of >150° was observed for all samples. The increment in the AP content reduced the sliding angle for the water droplet on the coated surface. This phenomenon may be attributed to the improved roughness on the wood substrate because of the improved dispersion of the WSL10 in the AP binder system, as demonstrated by the stability study (FIG. 6). An air-trapping surface structure is essential for the development of low-sliding-angle surfaces [109]. Similar to the stability analysis, the formula with the mixing ratio of 1:1 for WSL10/AP generated the coated surface with acceptable hydrophobicity, while keeping the coating formula green. The better surface properties of this formulation follows the same trend of suspension stability, implying that the stability of the suspension might have contributed to the development of a uniform coated wood surface as a result of lower sliding angle.

Superhydrophobic coatings are useful for applications that require water resistance, but these surfaces can also be subjected to other chemical environments, requiring the analysis of the coated surface in other chemical environments. The static contact angle and sliding angle of various solutions on the wood sample coated with 1/1 wt. ratio of WSL10 and AP are shown in FIGS. 10b and 10c. It is seen that only ethylene glycol and NaOH solution droplets had small contact angle values on the coated wood surface. The strong alkaline solution (NaOH) may develop a non-oxidation reduction reaction between the silanol group of WSL10 and NaOH, leading to the decomposing of silanol groups of WSL10 [110, 111]. On the other hand, the presence of two organic CHs groups in the WSL10 structure (FIG. 1b) is responsible for the wetting of the coating exposed to ethylene glycol droplets. Hence the strong attraction force between the ethylene glycol (hydrophobic in nature) droplet and the coated surface would lead to the surface wetting [112]. The analysis shows a higher contact angle for acidic droplets, implying good chemical resistance and superhydrophobicity. The stability of high contact angle results at high water temperatures and in various chemical conditions demonstrates the surface's durability.

The force required to remove a liquid droplet from the surface it encounters is known as the adhesion force of liquid droplet on the surface [113]. The measurement of adhesion force is an efficient method for quantifying the interactions between liquid and solid surfaces. FIGS. 10d and 10e shows the adhesion force of water droplets on the coated wood surface as a function of its position. This analysis was performed on the AP, SKL-AP, and WSL 10-AP coated surfaces, and the results are shown in FIG. 10d. As can be seen, three steps are involved in this process: spreading, maximal adhesion, and separation (Pull-off) of the water droplets from the coated surface. AP and SKL-AP coated wood had hydrophobic surfaces where the water droplet attached to the surface and a pull off force required for extracting a water droplet from the surface was 0.28 mN and 0.25 mN, respectively. On the other hand, the wood surfaces that were coated with WSL 10-AP (1:1 wt. ratio) exhibited less droplet spreading, and a pull-off force of 0.025 mN. The droplet left no residue of water on the surface after contact with the coated surface for WSL 10-AP (FIG. 10e) confirming its superhydrophobicity. Those results are consistent with the contact angle analysis of coated wood surfaces (FIG. 10a) and the surface morphology confirming that the micro and nano hierarchical structure of coated wood surface improved the superhydrophobicity of wood (FIG. 9k).

### Example 12—Ignition Performance of Coated Wood

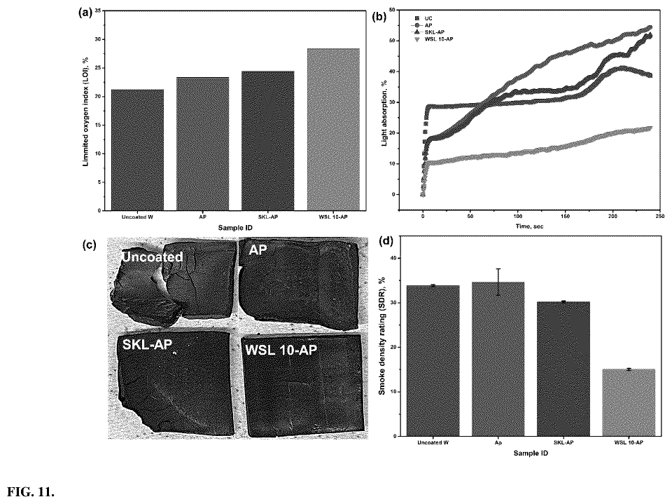

The Limited oxygen Index (LOI) results of the samples are shown in FIG. 11a. The coated sample with WSL10-AP had a 27.4% LOI value, which was higher than that of other samples. Such an improvement may be attributed to the integration of silsesquioxane into the structure of WSL10 making it more flame resistant [114]. The increased LOI value of the coating formulation containing WSL10 (in comparison with that containing SKL) is due to the superior charring ability of WSL10 because the homogenous silsesquioxane on the backbone of SKL functions as a heat shield layer at a higher temperature, resulting in decreased flammability [115, 116]. This phenomenon is a result of its structural and thermal properties of WSL10 and as discussed in FIG. 7a. This delayed ignition characteristic is also reported when silsesquioxane is integrated in different polymer matrices, such as polyolefins, polyester, and polycarbonate due to the creation of a specific architectural structure [117].

Light absorption and smoke density rating of wood are important characteristics of wood ignition. FIGS. 11b and 11d depict the light absorption curves for the coatings and the smoke density ratings (SDR). It is observable that wood coated with WSL10-AP formula had the lowest light absorption and smoke density, indirectly inferring that this sample was less ignited and took a longer time for decomposition than other samples. The lowest rate of combustion obtained for WSL 10-AP is attributable to the possibility of producing a crosslinked ceramic phase upon heating, which might operate as a barrier to limit the spread of the flame, thereby allowing the wood to retain its structural integrity FIG. 11c. AP did not significantly increase the igniting performance of wood, while SKL improved it less than WSL10.

As will be appreciated by those of skill in the art, this means that the use of the copolymer in the AP binder system improved the flame retardance of the coated wood. That is, while unmodified lignin (SKL) with the binder (AP) also reduced the flammability of the wood, the performance of the copolymer (WSL 10) was better.

### Example 13—Flame Retardancy of Coated Wood

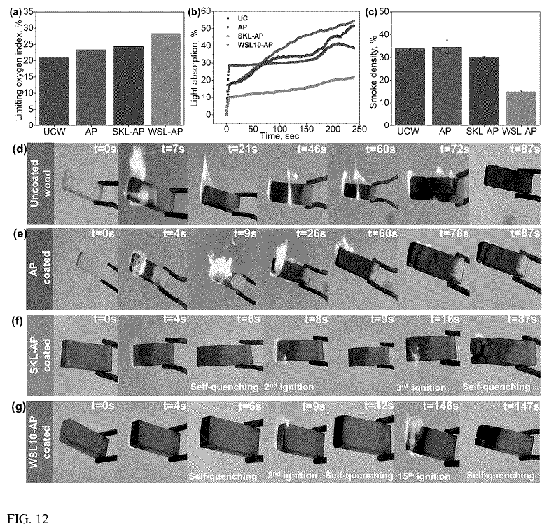

The flame retardance capabilities of the coatings were evaluated by limiting oxygen index (LOI), smoke density, and flame test. The findings can be shown in FIG. 12. The coated sample with WSL10-AP (1/1 wt./wt.) had a 27.4% LOI value, higher than other samples in FIG. 12(a). Such an improvement may be attributed to the integration of silsesquioxane into the structure of WSL10, making it more flame-resistant [114]. The increased LOI value of the coating formulation containing WSL10 (in comparison with that containing SKL) is due to the superior charring ability of WSL10 because the homogenous silsesquioxane on the backbone of SKL functions as a heat shield layer at a higher temperature, resulting in decreased flammability [115]. This phenomenon results from the structural and thermal properties of WSL10, as discussed in (FIG. 7). This delayed ignition characteristic is also reported when silsesquioxane is integrated into different polymer matrices, such as polyolefins, polyester, and polycarbonate, due to the creation of a specific architectural structure [117].

Light absorption and smoke density rating of wood are essential characteristics of wood ignition. FIGS. 12(b) and 12(d) depict the light absorption curves for the coatings and smoke density ratings (SDR). It is observable that wood coated with the WSL10-AP (1/1 wt.) formula had the lowest light absorption and smoke density, indirectly inferring that this sample was less ignited and took longer for decomposition than other samples. The lowest rate of combustion obtained for WSL10-AP is attributable to the possibility of producing a crosslinked ceramic phase upon heating, which might operate as a barrier to limit the spread of the flame, thereby allowing the wood to retain its structural integrity. AP did not significantly increase the igniting performance of wood, while SKL improved it less than WSL10 did.

The flame test was conducted to replicate a real-life fire, and the outcome is illustrated in FIG. 12(d-g). Uncoated wood, when exposed to propane gas, underwent a consistent and sustained igniting, with a flame that persisted for 72 seconds to burn the sample completely until extinguishing at 87 seconds. The AP-coated wood exhibited comparable properties to uncoated wood. However, the SKL-AP-coated wood demonstrated self-quenching properties. After the third ignition, the flame on the SKL-AP-coated wood remained steady for 87 seconds. The wood coated with WSL10-AP exhibited a significantly reduced inclination for igniting. It required 15 ignition attempts before a noticeable flame was observed on the coating, and the flame extinguished before almost one-third of the wood had burned.

### Example 14—Durability of Superhydrophobic and Flame-Retardant Properties of Wood

Superhydrophobic coatings are useful for applications that require water resistance. Still, these surfaces can be subjected to other chemical environments, requiring the analysis of the coated surface in different chemical environments. The static contact angle and sliding angle of various solutions on the wood sample coated with 1/1 wt./wt. of WSL10 and AP are shown in FIGS. 10(b) and 10(c). It is seen that only ethylene glycol and NaOH solution droplets had small contact angle values on the coated wood surface. The strong alkaline solution (NaOH) may develop a non-oxidation reduction reaction between the silanol group of WSL10 and NaOH, leading to the decomposing of silanol groups of WSL10 [120]. On the other hand, two organic CHs groups in the WSL10 structure (FIG. 1(b)) caused the coating to be wetted to ethylene glycol droplets. Hence, the strong attraction force between the ethylene glycol (having a hydrophobic nature) droplet and the coated surface would lead to surface wetting [121]. The analysis shows a higher contact angle for acidic droplets, implying good chemical resistance and superhydrophobicity. The stability of high contact angle results at high water temperatures and in various chemical conditions, demonstrating the surface's durability.

The bonding between the coated layer and the surface, as well as the durability of the coated layer, were assessed by sand abrasion, touching, and knife-cutting experiments on the wood coated with WSL10-AP (1/1 wt. ratio), which was followed by WCA analysis. The sand abrasion test result followed by WCA shows that the coated layer could maintain the superhydrophobic characteristics until 90 cm abrasion. However, beyond 90 cm, the WCA starts to reduce. The WCA remained above 140° until a friction distance of 150 cm, after which the WCA declined dramatically. The finger-touching and knife-cutting test on the coating exhibited a WCA of larger than 150° and a sliding angle of smaller than 10°. These results demonstrate a strong adherence of the coated layer to wood and confirm its durability. The strong adhesion of the coating to the wood surface is due to the penetrating properties of AP beyond the wood surface and the potential covalent link between AP and wood, resulting in a robust interface between the adhesive and wood cell wall [122, 123].

Furthermore, results indicate that the coating maintained its superhydrophobic properties even after a prolonged period of storage (i.e., 6 months) at room temperature. In addition, the resistance of the superhydrophobic coating to temperature was verified by observing a WCA greater than 150° even after subjecting it to a temperature of 200° C. for 2 hours. Furthermore, the coating's flame retardancy after temperature exposure was demonstrated by its ability to withstand ignition three times and self-quench after the fourth ignition [124]. After 88 seconds, one-third of the wood remained unaffected, as determined by the flame test.

### Example 13—Material and Methods

### Materials

Softwood kraft lignin (SKL) was obtained from FPInnovations, which was produced via LignoForce technology. Aminopropyl/methyl silsesquioxane (WAPMSS) oligomer was purchased from Gelest Inc. USA. Sodium hydroxide (NaOH), deuterated sodium hydroxide (NaOD), deuterium oxide (D₂O-d₂), deuterated dimethyl sulfoxide (DMSO-d₆), hydrochloric acid (HCl) 37%, 2-chloro-4,4,5,5-tetramethyl-1,3,2-dioxaphospholane (TMDP), chloroform (CDCl₃), ethanol (95%), pyridine, cyclohexanol (99%), chromium (Ill) acetylacetonate (97%), aluminum hydroxide, orthophosphoric acid, toluene, and ethylene glycol were all purchased from Millipore Sigma, Oakville, Canada. Also, nylon membrane syringe filters with 0.45 μm pore openings were purchased from Fisher Scientific, Ottawa, Canada. A dialysis membrane (1,000 g/mol cut off) was obtained from spectrum labs.

### Preparation of SKL-WAPMSS (WSL) Polymers

The polymerization of SKL and WSL were conducted in an aqueous environment following the polycondensation reaction [35]. Taguchi L9 3×4 orthogonal array experimental design was used to analyse the effect of concentration, time, temperature, and pH of the reaction on the properties of induced polymers. In this set of experiments, an SKL aqueous solution was prepared (25 g/L) in a three-neck round bottom flasks equipped with magnetic stirrer (200 rpm) and different concentrations of WAPMSS were added to the suspension to make different molar ratios of SKL/WAPMSS (1:0.4, 1:1.1 or 1:2.3). The pH of the system was adjusted to 10, 11, or 12 using 1 M NaOH and the system was refluxed at three different temperatures (40, 60, or 80° C.) for three different periods (24, 48, or 72 h). Upon completion of the reaction, the product was centrifuged, washed three times with toluene to remove any remaining unreacted chemicals. The supernatant was resuspended in water and neutralized with 1M of HCl, followed by dialysis for 24 hours, and dried in a standard oven at 60° C. for 48 hr. Reaction parameters were optimised using the design expert software based on the percent yield and grafting ratio estimated using equations S1 and S2. The reaction under the conditions of pH 11, 60° C., and 48 hours, and a 1:1.2 mmol ratio of SKL/WAPMSS were found to be the optimum for obtaining the polymer, WSL10.

### Characterization of WSL Copolymers

### Nuclear Magnetic Resonance (NMR)

The structural analysis of SKL, WAPMSS, and copolymers was performed by proton nuclear magnetic resonance (¹H-NMR) and heteronuclear single quantum coherence NMR (HSQC), using nuclear magnetic resonance spectroscopy (Bruker AVANCE Neo NMR-500 MHz apparatus USA) with top spin 4.02 version software. In this analysis, 60-70 mg of oven dried copolymers or WAPMSS were dissolved in 1 mL of D₂O and 2 μL of 40% NaOD, while 60-70 mg of SKL was mixed for 12 h in 1 mL of DMSO-d at room temperature [46-48]. ¹H NMR test parameters were 16 scans, 3.28 sec acquisition time with 1 s relaxation and 90° pulse at room temperature. HSQC analysis was conducted using 13 ppm spectra width in the F2 (¹H) dimension with 2048 data point (155 ms acquisition time), 165 ppm spectra width in the F1 (¹³C) dimension with 256 data point (6.2 ms acquisition time), a 1.5 s pulse delay, and sixteen scans at room temperature, which was assessed by Bruker pulse program “hsqcetgpsisp2.3 software.

The phenolic, aliphatic, and carboxylic hydroxyl groups of SKL and copolymers were quantified by P-NMR analysis, as described previously [49]. In short, 50-60 mg of oven dried (at 60° C.) samples were dissolved in 1 mL mixture of chloroform-d (CDCl₃), and pyridine (1:1.6 vol/vol) followed by the addition of 52 μL (5 g/L) relaxing agent (chromium (Ill) acetylacetonate) and the mixture was stirred at 120 rpm for 12 h. Then, 200 μL of phosphorylating reagent (2-chloro-4,4,5,5-tetramethyl-1,3,2-dioxaphospholane (TMDP) was introduced to the sample solutions, and the mixture was agitated at 120 rpm for 1 h. After that, 50 μL internal standard (cyclohexanol, (20 g/L)) was added to the mixture, and the system was agitated for 30 min. Then, the solutions were transferred to NMR tubes and analyzed by the NMR instrument with 1024 scans per sample with 90° pulse width and 5 sec relaxation delay.

### Fourier Transform Infrared Spectroscopy (FTIR)

Fourier Transform Infrared Spectroscopy (FTIR) was used for analyzing the structure of the samples. In this set of experiments, 60-80 mg of dried, crushed lignin derivatives were deposited on the Total Reflectance (ATR) crystal of Bruker Tensor 37 (Bruker, Germany) with a PIKE MIRacle Diamond Attenuated FTIR instrument. Then, 32 scans were conducted for each sample with a resolution of 4 cm⁻¹ at wavenumber range of 500 and 4000 cm⁻¹.

### X-Ray Photoelectron Spectroscope (XPS)

The surface chemical compositions of the samples were investigated using an X-ray photoelectron spectrometer (XPS) analyzer (Kratos AXIS Supra, Shimadzu Group Company, Japan), which was equipped with a dual anode AL/Ag monochromatic X-ray source (1486.7 eV). Oven dried samples (60° C.) were placed on double-sided carbon tape and fed through the XPS equipment. The number of steps, dwell and sweep times were 230, 260, and 60 s, respectively. ESCApe™ (1.4.0.1149) software (Kratos Analytical, Japan) was used to obtain the spectra and quantify the chemical bonds. The percentage of surface elemental composition was determined, and the concentration of elemental silicon in the products was used for calculating the grafting efficiency of the reaction (as per equation S2 in the supplementary material) [50]. After TGA analysis, the chemical compositions of WSL10 samples were analysed using XPS following the same conditions.

### Light Scattering Analysis

Static light scattering technique (SLS) was used for assessing the molecular weight (MW) and radius of gyration (R_{g}) of SKL and copolymers [51,]. In this technique, a laser light scattering instrument that was attached to a goniometer (BI-200SM, Brookhaven Instruments Corporation, NY, USA) was used for analyzing the characteristics of the polymers in solutions at the laser power of 35 mW and a wavelength of 637 nm at room temperature. The MW and R_{g} were determined by measuring the intensity of the scattered light at various scattering angles ranging from 20° to 155°. Five concentrations (0.2, 0.6, 1.2, 1.6, and 2.1 mg/mL) of each copolymer were prepared in a 15% NaOH solution, which were stirred for 24 hours at room temperature. After filtration using 0.45 μm nylon filters, the samples were analyzed by the instrument via Brookhaven Zimm plot software [52]. BI-DNDC differential refractometer (Brookhaven Instruments Corporation, NY, USA) at 620 nm was used to measure the refractive index increment (dn/dc) of the solutions.

Hydrodynamic radius (Rh) of the samples were analysed following the dynamic light scattering technique (DLS) by the same instrument. First, 1 mg/mL of the polymer solutions were prepared in 15% NaOH, which was stirred for 24 hours at room temperature [53]. Analyses were conducted in triplicate immediately after filtration using 0.45 μm nylon membrane syringe filters, and the average values were reported. The shape factor was determined by dividing the value of R_{g} from the SLS analysis by the value of Rh from the DLS analysis [54].

### Powder Wettability Analysis

The wettability of SKL and WSL copolymers with water was determined following the Washburn technique and using a force tensiometer (attention sigma 700/701, Biolin Scientific, Finland) with a powder glass probe [55]. The Washburn method measures the capillary rise of the liquid into particles. In a series of experiments, 100 mg of SKL or WSL copolymer was placed into a cylindrical glass tube with an open base bottom, which was then covered with filter paper and taped three times to ensure a proper packing. As the powder holder was immersed into the liquid, the amount of liquid absorbed by the powder bed was measured as a function of time to determine the wettability of the copolymers according to equation 1 [56].

W²=Cργl cos θt/2η (1)

where W is the weight of absorbed water (g), C is a geometric constant (0.04), ρ is the liquid density (0.998 g/mL), γ is surface tension (72.8 mN/m), L is the length of the powder glass probe (5.5 mm), η is the viscosity of the liquid (0.01 g/cm·s), and t is measurements time (300 s).

### Thermal Analysis

The thermal stability analysis is an important aspects of coating materials. Thermal stability and degradation temperature of SKL and copolymers were investigated by thermogravimetric analysis (TGA) instrument (TGAi1000, Instrument Specialists Inc., WI, USA). The instrument was loaded with 10-10.36 mg of dried samples in a Tzero® aluminium pan. The analysis was conducted in a nitrogen environment with a flow rate of 10 mL/min and a heating rate of 10° C./min from 25° C. to 800° C. [57]. For further temperature effect analysis, WSL10 copolymer sample were analysed at six different temperature ranges (10-220, 10-360, 10-420, 10-520, 10-620 and 10-800° C.) following similar heating rate and the residues from each temperature range were collected for the XPS analysis.

Differential scanning calorimetry (DSC) instrument (DSC Q2000, TA Instruments, DE, USA) was employed to determine the glass transition temperature (T_{g}) of SKL and copolymers [8]. In this analysis, 7 to 10 mg of oven dried (60° C.) samples was placed in an Tzero® aluminum pan and fed to the DSC instrument. The thermal history of samples was erased by heating and cooling them successively from 20° C. to 250° C. and cooling to 20° C. at a rate of 5.0° C./min. The T_{g} of SKL and copolymers was obtained by performing a second heating cycle from 20 to 250° C.

### Coating Formulation and Process

The coating formulation was prepared by mixing aluminum phosphate (AP) binder and the copolymer (WSL10), which was produced under the optimized conditions of 1:1.2 mmol ratio of SKLWAPMSS, pH 11, 60° C., and for 48 hours. First, AP binder was produced by combining aluminum hydroxide (Al(OH)), 1 M, and orthophosphoric acid (H₃PO₄, 60%), 3 M, in a three-neck round-bottom flask with magnetic stirring at 200 rpm and 100° C. for 3 hours [59]. WSL10 copolymer and AP binder were mixed in water vigorously using a vortex, which was followed by magnetic stirring at 1000 rpm for one hour. Wood substrate was ultrasonically rinsed with deionized water and dried in 60° C. oven for 2 h. The wood samples were deep coated in the prepared dispersion for 5 min and cured at 100° C. for 15 min. The control samples were consisted of two different formulations, one that contained only AP binder, and another one containing SKL and AP binder in a 1/1 wt. ratio, which was selected based on the result obtained from stability and contact angle analysis.

### Stability of Coating Formulation

In this test, 25 mL of coating formulations (F1-F8) were placed in cylindrical glass vials and then scanned every 30 s for six hours at 30° C. by a suspension stability analyzer, Turbiscan lab expert (Formulation, France) [60].

### Surface Analysis

### Contact and Sliding Angle Analysis of Coated Wood

Optical tensiometer (Theta Lite, Bolin scientific, Finland) equipped with a digital camera and manual tilting stage was utilized for static contact analysis. For static contact angle analysis, the sessile liquid droplet method from one attention software was applied [61]. In this test, a droplet of liquid with a diameter of 6-10 μm was placed on a coated wood surface, and the contact angle of the droplet and coated surface was measured visually by a camera for 50 sec.

To measure the sliding angle of water on the wood surface, tilting method was used. In this test, first a water droplet (between 6 and 10 μL) was placed on the coated wood at a flat configuration (180°) on the tilting stage, and the sample stage was incrementally tilted until the droplet started to slide [62]. Both analyses were performed on wood surfaces coated with all the formulations (1/0.25, 1/0.5, 1/0.75, 1/1, 1/1.25, 1/1.5, 1/75, and 1/2 wt. gram ratio of WSL10 to AP), and control samples (uncoated wood, AP coated and AP-SKL coated). The measurement was replicated three times and mean values with standard deviation were reported.

### Water Droplet Adhesion

The adhesion force is equal to the force required to remove a liquid (water) droplet from a surface [63]. For this test, force tensiometer instrument (attention sigma 700/701, Biolin Scientific, Finland) equipped with an adhesion probe ring and a microbalance was utilized. First, a water droplet (10 μL) was delicately positioned on an adhesion probe ring, the probe was lowered until the water droplet adhered to the coated surface. After 2 min, the probe was elevated with a velocity of 5 μm/s and adhesion force results were collected. This analysis was conducted on coated wood surfaces with AP, SKL-AP, and WSL10-AP at 1/1 wt. ratio formulations. The procedure was performed three times and at three different parts of the coated samples.

### Scanning Electron Microscope (SEM) Analysis

The images of uncoated and coated woods with different formulas for uncoated, AP, SKL-AP, and WAL 10-AP (1/1 wt. gram ratio) were produced using a field emission scanning electron microscope (FE-SEM, Hitachi SU-70). The samples were gold coated prior to the SEM observation. The conditions for this experiment were 5.0 kV accelerating voltage in a vacuum (10-4-10-3 Pa) with a 100× to 10,000× magnifications.

### Thermal Analysis of Coated Wood

### Limited Oxygen Index (LOI) Measurement

The limiting oxygen index (LOI) analyzer (NETZSCH TAURUS instrument, Germany) was used to determine the minimum oxygen required for the ignition of the coated samples following ASTM D2863 standards [64]. A precisely controlled environment of nitrogen and oxygen was used to burn the coated wood that was vertically positioned in the center of the glass column. The lowest oxygen in the carrier gas flow, or LOI, was determined to be the point at which full, blazing combustion of the copolymers was seen [65]. The samples were prepared in a dimension of 140 mm×20 mm×10 mm, and five replicas were used for each sample.

### Smoke Density Analysis

For determining the smoke emission properties of the coated wood, an ASTM D 2843-99 method was followed via studying the smoke generation profile of the coated wood samples using a smoke density test device (AIC-2843, Advanced instrument co., Ltd, China). The coated samples, 42 mm×42 mm×4 mm, were placed in the instrument, and then the samples were subjected to the pressure of 0.14 MPa of propane gas for 250 seconds after ignition [66]. The smoke density rating, also known as the SDR, of the samples was analyzed and presented, along with the light absorption curves. Both metrics were obtained from the light absorption data.

### Flame Retardancy of Coated Wood

The limiting oxygen index (LOI) analyzer (NETZSCH TAURUS instrument, Germany) was used for determining the minimum oxygen required for the ignition of the uncoated wood, AP, KL-AP, and WSL10-AP (1/1 wt. ratio) coated wood samples following the ASTM D2863 standard. A precisely controlled environment of nitrogen and oxygen was used to burn the coated wood vertically positioned in the center of the glass column. The lowest oxygen in the carrier gas flow, known as the limiting oxygen index or LOI, was determined to be the point at which complete, blazing combustion of the material was seen [118]. The samples were prepared in a dimension of 140 mm×20 mm×10 mm, and five replicas were used for each sample. To assess the smoke emission characteristics of the coated wood, the ASTM D 2843-99 method was employed. This involved examining the smoke generation patterns of uncoated wood, AP, SKL-AP, and WSL10-AP (1/1 wt. ratio) coated wood samples using a smoke density test device (AIC-2843, Advanced Instrument Co., Ltd, China).

To analyze the smoke density performance of the materials, the coated samples, 42 mm×42 mm×4 mm in dimensions, were placed in the instrument, and then the samples were subjected to the pressure of 0.14 MPa of propane gas for 250 s after ignition [108]. The samples' smoke density rating, the SDR, and the light absorption curves were analyzed and presented. SDR measures the smoke concentration, while the light absorption curve quantifies the extent to which smoke particles absorb light during combustion. Both metrics were obtained from the light absorption data. To simulate real-life fire scenarios, samples were subjected to an intense propane gas flame to initiate ignite. Images were captured to depict the reaction of the samples visually.

### Durability of the Coating Formulation

The resistance of the coating to hot water, milk, coffee, 0.1M NaOH, 0.1M HCl, and ethyl glycol was evaluated using liquid droplets through the measurement of contact angles using an optical tensiometer. The sandpaper abrasion, touching, and knifing tests were conducted on WS10-AP 1/1 wt. ratio coated wood samples to assess the bonding and durability of the coated wood. A sandpaper abrasion test was performed using a 20 g load with the coating upside down and subjected to 1500 CW sandpaper. The coating was then pushed along a straight line [125], and the contact angle of a water droplet on the surface was tested. Alternatively, the endurance of the coating was assessed through the repeated application of knife cutting and finger touching before the WCA measurement. In addition, the WCA of the coated wood was determined after six months of storage at room temperature. Furthermore, the resistance of the coating to temperature was evaluated by subjecting it to a temperature of 200° C. for 2 h, followed by WCA assessment and flame test [119].

While the preferred embodiments of the invention have been described above, it will be recognized and understood that various modifications may be made therein, and the appended claims are intended to cover all such modifications which may fall within the spirit and scope of the invention.

### REFERENCES

1. Obata, Y., et al., Research on better use of wood for sustainable development: quantitative evaluation of good tactile warmth of wood. Energy, 2005. 30(8): p. 1317-1328.
2. Ramage, M. H., et al., The wood from the trees: The use of timber in construction. Renewable and Sustainable Energy Reviews, 2017. 68: p. 333-359.
3. Wang, L., A. Toppinen, and H. Juslin, Use of wood in green building: A study of expert perspectives from the UK. Journal of cleaner production, 2014. 65: p. 350-361.
4. Rowell, R. M. and W. B. Banks, Water repellency and dimensional stability of wood. Gen. Tech. Rep. FPL-50. Madison, WI: US Department of Agriculture, Forest Service, Forest Products Laboratory; 1985: 24 pages, 1985. 50.
5. Wang, S., et al., Fabrication of superhydrophobic wood surface by a sol-gel process. Applied Surface Science, 2011. 258(2): p. 806-810.
6. Wang, C., C. Piao, and C. Lucas, Synthesis and characterization of superhydrophobic wood surfaces. Journal of Applied Polymer Science, 2011. 119(3): p. 1667-1672.
7. Janesch, J., et al., Superhydrophobic coatings on wood made of plant oil and natural wax. Progress in Organic Coatings, 2020. 148: p. 105891.
8. Bayer, I. S., Superhydrophobic coatings from ecofriendly materials and processes: a review. Advanced Materials Interfaces, 2020. 7(13): p. 2000095.
9. Crick, C. R. and I. P. Parkin, Water droplet bouncing-a definition for superhydrophobic surfaces. Chemical Communications, 2011.47(44): p. 12059-12061.
10. Law, K.-Y., Definitions for hydrophilicity, hydrophobicity, and superhydrophobicity: getting the basics right. 2014, ACS Publications. p. 686-688.
11. Hooda, A., et al., A review on fundamentals, constraints and fabrication techniques of superhydrophobic coatings. Progress in Organic Coatings, 2020.142: p. 105557.
12. Vazirinasab, E., R. Jafari, and G. Momen, Application of superhydrophobic coatings as a corrosion barrier: A review. Surface and Coatings Technology, 2018.341: p. 40-56.
13. Nguyen-Tri, P., et al., Recent progress in the preparation, properties and applications of superhydrophobic nano-based coatings and surfaces: A review. Progress in organic coatings, 2019. 132: p. 235-256.
14. Bayer, I., et al., Solvent resistant superhydrophobic films from self-emulsifying camauba wax-alcohol emulsions. Soft Matter, 2011. 7(18): p. 7939-7943.
15. Gupta, S., J. Iwala, and H. Grewal, Development of natural wax based durable superhydrophobic coatings. Industrial Crops and Products, 2021. 171: p. 113871.
16. Saji, V. S., Wax-based artificial superhydrophobic surfaces and coatings. Colloids and Surfaces A: Physicochemical and Engineering Aspects, 2020. 602: p. 125132.
17. Zhang, W., et al., Fabrication of superhydrophobic paper surface via wax mixture coating. Chemical Engineering Journal, 2014. 250: p. 431-436.
18. Badre, C., et al., Effects of nanorod structure and conformation of fatty acid self-assembled layers on superhydrophobicity of zinc oxide surface. Journal of colloid and interface science, 2007. 316(2): p. 233-237.
19. Hu, Z., et al., Water resistance improvement of paper by superhydrophobic modification with microsized CaCO3 and fatty acid coating. Colloids and Surfaces A: Physicochemical and Engineering Aspects, 2009. 351(1-3): p. 65-70.
20. Chen, L., et al., Fatty-Acid-Metal-lon complexes as multicolor superhydrophobic coating materials. Chemistry—An Asian Journal, 2011. 6(7): p. 1757-1760.
21. Xu, W., et al., Superhydrophobic copper surfaces fabricated by fatty acid soaps in aqueous solution for excellent corrosion resistance. Applied Surface Science, 2017. 399: p. 491-498.
22. Li, S., S. Zhang, and X. Wang, Fabrication of superhydrophobic cellulose-based materials through a solution-immersion process. Langmuir, 2008.24(10): p. 5585-5590.
23. Guo, J., et al., Superhydrophobic and slippery lubricant-infused flexible transparent nanocellulose films by photoinduced thiol-ene functionalization. ACS Applied Materials & Interfaces, 2016. 8(49): p. 34115-34122.
24. Ye, M., et al., Nanofibrillated cellulose-based superhydrophobic coating with antimicrobial performance. Advanced Composites and Hybrid Materials, 2023. 6(1): p. 1-10.
25. Bayer, I. S., et al., Superhydrophobic cellulose-based bionanocomposite films from Pickering emulsions. Applied Physics Letters, 2009. 94(16): p. 163902.
26. Huang, J., et al., Preparation of a robust cellulose nanocrystal superhydrophobic coating for self-cleaning and oil-water separation only by spraying. Industrial Crops and Products, 2018. 122: p. 438-447.
27. Gu, L., et al., Effect of lignin on performance of lignocellulose nanofibrils for durable superhydrophobic surface. Cellulose, 2019. 26(2): p. 933-944.
28. Zhong, Y., et al., Green and superhydrophobic coatings based on tailor-modified lignocellulose nanofibrils for self-cleaning surfaces. Industrial & Engineering Chemistry Research, 2019. 58(44): p. 20323-20330.
29. Chirkova, J., et al., Lignins as agents for bio-protection of wood: 11th EWLP, Hamburg, Germany, Aug. 16-19, 2010. 2011. 65(4): p. 497-502.
30. Hua, Q., et al., Aqueous dispersions of esteriled lignin particles for hydrophobic coatings. Frontiers in chemistry, 2019: p. 515.
31. Thébault, M., et al., Effect of phenolation, lignin-type and degree of substitution on the properties of lignin-modified phenol-formaldehyde impregnation resins: Molecular weight distribution, wetting behavior, rheological properties and thermal curing profiles. Journal of renewable materials: JRM, 2020. 8(6): p. 603-630.
32. An, L., et al., One-step silanization and amination of lignin and its adsorption of Congo red and Cu(II) ions in aqueous solution. International Journal of Biological Macromolecules, 2020. 159: p. 222-230.
33. de Haro, J. C., et al., Lignin-Based Anticorrosion Coatings for the Protection of Aluminum Surfaces. Acs Sustainable Chemistry & Engineering, 2019. 7(6): p. 6213-6222.
34. Devadasu, S., et al. Development of ultra-high build self-healing coatings using amino silanized lignin nanocapsules. in 2nd International Conference on Aspects of Materials Science and Engineering (ICAMSE). 2021. Chandigarh, INDIA.
35. Salthammer, T., S. Mentese, and R. Marutzky, Formaldehyde in the indoor environment. Chemical reviews, 2010. 110(4): p. 2536-2572.
36. Tronc, F., L. Lestel, and S. Boileau, Polycondensation using hydrosilylation: a tool for preparing tailor-made polysiloxanes with anchoring groups. Polymer, 2000. 41(13): p. 5039-5046.
37. Ding, H., et al., High hydrophobic poly(lactic acid) foams impregnating one-step Si-F modified lignin nanoparticles for oil/organic solvents absorption. Composites Communications, 2021. 25.
38. Mali, P., et al., Morphology of wood degradation and flame retardants wood coating technology: an overview. International Wood Products Journal, 2022. 13(1): p. 21-40.
39. Kramer, N. E., L. M. A. Barnett, and B. S. Cummings, Nephrotoxicity of flame retardants: An understudied but critical toxic endpoint. Current Opinion in Toxicology, 2022: p. 100359.
40. Yu, Y., et al., Interface nanoengineering of a core-shell structured biobased fire retardant for fire-retarding polylactide with enhanced toughness and UV protection. Journal of Cleaner Production, 2022. 336: p. 130372.
41. Taib, M. N. A. M., et al., Current progress of biopolymer-based flame retardant. Polymer Degradation and Stability, 2022: p. 110153.
42. Solihat, N. N., et al., Recent developments in flame-retardant lignin-based biocomposite: manufacturing, and characterization. Journal of Polymers and the Environment, 2022: p. 1-21.
43. Yang, H., et al., Lignin-derived bio-based flame retardants toward high-performance sustainable polymeric materials. Green chemistry, 2020. 22(7): p. 2129-2161.
44. Lu, X., A. F. Lee, and X. Gu, Improving the flame retardancy of sustainable lignin-based epoxy resins using phosphorus/nitrogen treated cobalt metal-organic frameworks. Materials Today Chemistry, 2022. 26: p. 101184.
45. Lu, X., et al., Thermal performance and thermal decomposition kinetics of a novel lignin-based epoxy resin containing phosphorus and nitrogen elements. Journal of Thermal Analysis and Calorimetry, 2022. 147(8): p. 5237-5253.
46. Crestini, C., et al., On the structure of softwood kraft lignin. Green Chemistry, 2017. 19(17): p. 4104-4121.
47. Tran, F., et al., Selective modification of the β-β linkage in DDQ-treated Kraft lignin analysed by 2D NMR spectroscopy. Green Chemistry, 2015. 17(1): p. 244-249.
48. Yuan, T.-Q., et al., Characterization of lignin structures and lignin-carbohydrate complex (LCC) linkages by quantitative 13C and 2D HSQC NMR spectroscopy. Journal of agricultural and food chemistry, 2011. 59(19): p. 10604-10614.
49. Meng, X., et al., Determination of hydroxyl groups in biorefinery resources via quantitative 31P NMR spectroscopy. Nature protocols, 2019. 14(9): p. 2627-2647.
50. Fang, R., et al., Research on the graft copolymerization of EH-lignin with acrylamide. Natural Science, 2009. 1(01): p. 17.
51. Tolbert, A., et al., Characterization and analysis of the molecular weight of lignin for biorefining studies. Biofuels, Bioproducts and Biorefining, 2014. 8(6): p. 836-856.
52. Contreras, S., et al., Propensity of lignin to associate: light scattering photometry study with native lignins. Biomacromolecules, 2008. 9(12): p. 3362-3369.
53. Bui, H. L., et al., Catechol-functionalized sulfobetaine polymer for uniform zwitterionization via pH transition approach. Colloids and Surfaces B: Biointerfaces, 2022. 220: p. 112879.
54. Wilcox, K. G., et al., Persistence length of α-helical poly-l-lysine. Soft Matter, 2022. 18(35): p. 6550-6560.
55. Alwadani, N., N. Ghavidel, and P. Fatehi, Surface and interface characteristics of hydrophobic lignin derivatives in solvents and films. Colloids and Surfaces A: Physicochemical and Engineering Aspects, 2021. 609: p. 125656.
56. Alghunaim, A., S. Kirdponpattara, and B.-m. Z. Newby, Techniques for determining contact angle and wettability of powders. Powder Technology, 2016. 287: p. 201-215.
57. Faravelli, T., et al., Detailed kinetic modeling of the thermal degradation of lignins. Biomass and bioenergy, 2010. 34(3): p. 290-301.
58. Sen, S., S. Patil, and D. S. Argyropoulos, Thermal properties of lignin in copolymers, blends, and composites: a review. Green Chemistry, 2015. 17(11): p. 4862-4887.
59. Liu, M., et al., An all-water-based system for robust superhydrophobic surfaces. Journal of colloid and interface science, 2018. 519: p. 130-136.
60. De Paola, M. G., et al., Multiple light scattering as a preliminary tool for starch-based film formulation. Journal of Phase Change Materials, 2021. 1(2).
61. Park, J., et al., Shape of a large drop on a rough hydrophobic surface. Physics of Fluids, 2013. 25(2): p. 022102.
62. Hao, P., et al., Sliding behavior of water droplet on superhydrophobic surface. EPL (Europhysics Letters), 2010. 90(6): p. 66003.
63. Sun, Y., et al., Spreading and adhesion forces for water droplets on methylated glass surfaces. Colloids and Surfaces A: Physicochemical and Engineering Aspects, 2020. 591: p. 124562.
64. Testing, A. S. f. and M. C. D.-o. Plastics, Standard Test Method for Measuring the Minimum Oxygen Concentration to Support Candle-like Combustion of Plastics (Oxygen Index). 2010: ASTM International.
65. Mamatha, B., et al., Development of Fire Retardant Wood Composite Using Amino Resin, in Wood is Good. 2017, Springer. p. 353-361.
66. Yan, L., Z. Xu, and N. Deng, Effects of polyethylene glycol borate on the flame retardancy and smoke suppression properties of transparent fire-retardant coatings applied on wood substrates. Progress in Organic Coatings, 2019. 135: p. 123-134.
67. Kazzaz, A. E., Z. H. Feizi, and P. Fatehi, Grafting strategies for hydroxy groups of lignin for producing materials. Green Chemistry, 2019. 21(21): p. 5714-5752.
68. Lancefield, C. S., et al., Identification of a diagnostic structural motif reveals a new reaction intermediate and condensation pathway in kraft lignin formation. Chemical science, 2018. 9(30): p. 6348-6360.
69. Jardim, J. M., et al., Insights into the potential of hardwood kraft lignin to be a green platform material for emergence of the biorefinery. Polymers, 2020. 12(8): p. 1795.
70. Nagy, M., et al., Characterization of CO 2 precipitated Kraft lignin to promote its utilization. Green Chemistry, 2010. 12(1): p. 31-34.
71. Mahmood, N., et al., Production of polyols via direct hydrolysis of kraft lignin: Effect of process parameters. Bioresource technology, 2013. 139: p. 13-20.
72. Li, S., et al., Thermally stable and tough coatings and films using vinyl silylated lignin. ACS Sustainable Chemistry & Engineering, 2018. 6(2): p. 1988-1998.
73. Gnanasekaran, D., et al., Ring opening metathesis polymerization of polyoctahedral oligomeric silsesquioxanes (POSS) incorporated oxanorbornene-5, 6-dicarboximide: synthesis, characterization, and surface morphology of copolymers. Australian Journal of Chemistry, 2011. 64(3): p. 309-315.
74. Riehle, N., et al., Data on the synthesis and mechanical characterization of polysiloxane-based urea-elastomers prepared from amino-terminated polydimethylsiloxanes and polydimethyl-methyl-phenyl-siloxane-copolymers. Data in brief, 2018. 18: p. 1784-1794.
75. Zhao, C., et al., Revealing Structural Differences between Alkaline and Kraft Lignins by HSQC NMR. Industrial & Engineering Chemistry Research, 2019. 58(14): p. 5707-5714.
76. Hoffmann, A., et al., Modification of Lignoboost Kraft Lignin from softwoods with dihydroxybenzenes. Reactive and Functional Polymers, 2019. 142: p. 112-118.
77. Abdelkafi, F., et al., Structural analysis of alfa grass (Stipa tenacissima L.) lignin obtained by acetic acid/formic acid delignification. Biomacromolecules, 2011. 12(11): p. 3895-3902.
78. An, L., et al., Fractionation of enzymatic hydrolysis lignin by sequential extraction for enhancing antioxidant performance. International journal of biological macromolecules, 2017. 99: p. 674-681.
79. Gwon, J. G., et al., Characterization of chemically modified wood fibers using FTIR spectroscopy for biocomposites. Journal of Applied Polymer Science, 2010. 116(6): p. 3212-3219.
80. McDonald, R. S., Surface functionality of amorphous silica by infrared spectroscopy. The Journal of Physical Chemistry, 1958. 62(10): p. 1168-1178.
81. Carlos de Haro, J., et al., Lignin-based anticorrosion coatings for the protection of aluminum surfaces. ACS Sustainable Chemistry & Engineering, 2019. 7(6): p. 6213-6222.
82. Chen, W.-H., et al., Silanization of solid surfaces via mercaptopropylsilatrane: a new approach of constructing gold colloid monolayers. RSC Advances, 2014.4(87): p. 46527-46535.
83. Chen, X., X. Wang, and D. Fang, A review on C1s XPS-spectra for some kinds of carbon materials. Fullerenes, Nanotubes and Carbon Nanostructures, 2020. 28(12): p. 1048-1058.
84. Stańczyk, K., et al., Transformation of nitrogen structures in carbonization of model compounds determined by XPS. Carbon, 1995. 33(10): p. 1383-1392.
85. Deng, Z.-W. and R. Souda, XPS studies on silicon carbonitride films prepared by sequential implantation of nitrogen and carbon into silicon. Diamond and related materials, 2002. 11(9): p. 1676-1682.
86. Arefmanesh, M., et al., Bromide-based ionic liquid treatment of hardwood organosolv lignin yielded a more reactive biobased polyol. Industrial & Engineering Chemistry Research, 2020. 59(42): p. 18740-18747.
87. Ghavidel, N., M. K. Konduri, and P. Fatehi, Chemical reactivity and sulfo-functionalization response of enzymatically produced lignin. Industrial Crops and Products, 2021. 172: p. 113950.
88. Ye, H., et al., Simple spray deposition of a water-based superhydrophobic coating with high stability for flexible applications. Journal of Materials Chemistry A, 2017. 5(20): p. 9882-9890.
89. Kaur, A., P. Chahal, and T. Hogan, Selective fabrication of SiC/Si diodes by excimer laser under ambient conditions. IEEE Electron Device Letters, 2015. 37(2): p. 142-145.
90. Kim, D., et al., Direct synthesis of polymer nanocapsules: self-assembly of polymer hollow spheres through irreversible covalent bond formation. Journal of the American Chemical Society, 2010. 132(28): p. 9908-9919.
91. Zhang, Y., et al., A novel route to thermosensitive polymeric core-shell aggregates and hollow spheres in aqueous media. Advanced Functional Materials, 2005. 15(4): p. 695-699.
92. Li, H., et al., Preparation of nanocapsules via the self-assembly of kraft lignin: A totally green process with renewable resources. ACS Sustainable Chemistry & Engineering, 2016. 4(4): p. 1946-1953.
93. Loman-Cortes, P., D. J. Jacobs, and J. L. Vivero-Escoto, Molecular dynamic simulation of polyhedral oligomeric silsesquioxane porphyrin molecules: Self-assembly and influence on morphology. Materials Today Communications, 2021. 29: p. 102815.
94. Chen, L., et al., Structure, bioactivity and applications of natural hyperbranched polysaccharides. Carbohydrate polymers, 2019. 223: p. 115076.
95. Yan, Y. Y., N. Gao, and W. Barthlott, Mimicking natural superhydrophobic surfaces and grasping the wetting process: A review on recent progress in preparing superhydrophobic surfaces. Advances in colloid and interface science, 2011. 169(2): p. 80-105.
96. Foorginezhad, S. and M. M. Zerafat, Fabrication of superhydrophobic coatings with self-cleaning properties on cotton fabric based on Octa vinyl polyhedral oligomeric silsesquioxane/polydimethylsiloxane (OV-POSS/PDMS) nanocomposite. Journal of colloid and interface science, 2019. 540: p. 78-87.
97. Ge, Q. and H. Liu, Rational design and preparation of superhydrophobic photo-cured hybrid epoxy coating modified by fluorocarbon substituted silsesquioxane-based nanoparticles. Progress in Organic Coatings, 2022. 172: p. 107089.
98. Kim, K., J. D. Lichtenhan, and J. U. Otaigbe, Facile route to nature inspired hydrophobic surface modification of phosphate glass using polyhedral oligomeric silsesquioxane with improved properties. Applied Surface Science, 2019. 470: p. 733-743.
99. Zhang, J., et al., A modified lignin adsorbent for the removal of 2, 4, 6-trinitrotoluene. Chemical Engineering Journal, 2011. 168(3): p. 1055-1063.
100. Cao, X., et al., Biodegradable and renewable UV-shielding polylactide composites containing hierarchical structured POSS functionalized lignin. International Journal of Biological Macromolecules, 2021. 188: p. 323-332.
101. Lan, Z., et al., Transparent, high glass-transition temperature, shape memory hybrid polyimides based on polyhedral oligomeric silsesquioxane. Polymers, 2019. 11(6): p. 1058.
102. Chung, H.-J., K.-S. Woo, and S.-T. Lim, Glass transition and enthalpy relaxation of cross-linked corn starches. Carbohydrate polymers, 2004. 55(1): p. 9-15.
103. Schwab, J. J. and J. D. Lichtenhan, Polyhedral oligomeric silsesquioxane (POSS)-based polymers. Applied organometallic chemistry, 1998. 12(10-11): p. 707-713.
104. Pomeroy, M., Coatings for gas turbine materials and long term stability issues. Materials & design, 2005. 26(3): p. 223-231.
105. Murashov, V. V. and J. Leszczynski, Adsorption of the phosphate groups on silica hydroxyls: an ab initio study. The Journal of Physical Chemistry A, 1999. 103(9): p. 1228-1238.
106. Zhang, J., et al., Suppression of peak tailing of phosphate prodrugs in reversed-phase liquid chromatography. Journal of Pharmaceutical and Biomedical Analysis, 2014. 98: p. 247-252.
107. Chen, T., et al., Constructing hydrophobic interfaces in aluminophosphate adhesives with reduced graphene oxide to improve the performance of wood-based boards. Composites Part B: Engineering, 2020. 198: p. 108168.
108. An, S. J., et al., Long-term lithium-ion battery performance improvement via ultraviolet light treatment of the graphite anode. Journal of The Electrochemical Society, 2016. 163(14): p. A2866.
109. Miwa, M., et al., Effects of the surface roughness on sliding angles of water droplets on superhydrophobic surfaces. Langmuir, 2000.16(13): p. 5754-5760.
110. Zhang, F., A. Li, and W. Zhao, Analysis of the acid and alkali resistance of superhydrophobic paper mulch. Cellulose, 2021. 28: p. 8705-8718.
111. Peng, C., Z. Chen, and M. K. Tiwari, All-organic superhydrophobic coatings with mechanochemical robustness and liquid impalement resistance. Nature materials, 2018. 17(4): p. 355-360.
112. Owen, M. J., Silicone hydrophobicity and oleophilicity. Silicon, 2017. 9: p. 651-655.
113. Sun, Y., et al., Direct measurements of adhesion forces of water droplets on smooth and patterned polymers. Surface Innovations, 2017. 6(1-2): p. 93-105.
114. He, Q., et al., Synergistic effects of polyhedral oligomeric silsesquioxane (POSS) and oligomeric bisphenyl A bis (diphenyl phosphate)(BDP) on thermal and flame retardant properties of polycarbonate. Journal of materials science, 2009. 44: p. 1308-1316.
115. Qian, Y., et al., Synthesis of a novel hybrid synergistic flame retardant and its application in PP/IFR. Polymer Degradation and Stability, 2011. 96(6): p. 1134-1140.
116. Fina, A., et al., Polyhedral oligomeric silsesquioxanes (POSS) thermal degradation. Thermochimica Acta, 2006. 440(1): p. 36-42.
117. Zhang, W., G. Camino, and R. Yang, Polymer/polyhedral oligomeric silsesquioxane (POSS) nanocomposites: An overview of fire retardance. Progress in Polymer Science, 2017. 67: p. 77-125.
118. E. D. Tomak, A. D. Cavdar, Limited oxygen index levels of impregnated Scots pine wood, Thermochim. Acta. 573 (2013) 181-185. https//doi.org/10.1016/j.tca.2013.09.022.
119. S. Jia, X. Lu, S. Luo, Y. Qing, N. Yan, Y. Wu, Efficiently texturing hierarchical epoxy layer for smart superhydrophobic surfaces with excellent durability and exceptional stability exposed to fire, Chemical Engineering Journal 348 (2018) 212-223. https//doi.org/10.1016/j.cej.2018.04.195.
120. M. Wang, D. Zhang, Z. Yang, C. Yang, Y. Tian, X. Liu, A contrastive investigation on the anticorrosive performance of stearic acid and fluoroalkylsilane-modified superhydrophobic surface in salt, alkali, and acid solution, Langmuir 36(34) (2020) 10279-10292. https//doi.org/10.1021/acs.langmuir.0c02080.
121. X. Qi, C. Li, X. Zou, L. He, Z. Liu, Z. Gao, Super-hydrophobic graphene-based high elastic sponge with superior photothermal effect for efficient cleaning of oil contamination, Chemical Engineering Journal 476 (2023) 146317. https//doi.org/10.1016/j.cej.2023.146317.
122. Z. Wu, T. Chen, J. T. Aladejana, Z. Zhang, S. Liang, Y. Xiao, J. Lin, X. A. Wang, Y. Xie, Eco-benign PVA/aluminum phosphate as an alternative to formaldehyde-based adhesives in wood-based panels, RSC advances 11(54) (2021) 34416-34423. https//doi.org/10.1039/D1RA05552F.
123. O. Olker, Wood adhesives and bonding theory, Adhesives-applications and properties (2016). https//doi.org/10.5772/65759.
124. S. S. Hussain, K. Sykam, R. Narayan, P. Basak, Self-extinguishable, intumescent poly (urethane-triazole) s as halogen-free flame retardant materials via bulk polymerization of azide-alkynes, Progress in Organic Coatings 188 (2024) 108228. https//doi.org/10.1016/j.porgcoat.2024.108228.
125. L. A. Lowden, T. R. Hull, Flammability behaviour of wood and a review of the methods for its reduction, Fire science reviews 2 (2013) 1-19. https//doi.org/10.1186/2193-0414-2-4.

TABLE 1
Taguchi L9 4 × 3 parameters (Lignin:oligomer molar ratio,
Temperature, Time, and pH) and three levels for each factor.

| | Lignin:oligomer | Temperature, | Time, | |
|---|---|---|---|---|
| Samples | mmol/mmol ratio | ° C. | h | pH |
| WSL 1 | 1:0.4 | 80 | 72 | 12 |
| WSL 2 | 1:1.1 | 40 | 48 | 12 |
| WSL 3 | 1:2.3 | 60 | 24 | 12 |
| WSL 4 | 1:2.3 | 40 | 72 | 11 |
| WSL 5 | 1:1.1 | 60 | 72 | 10 |
| WSL 6 | 1:2.3 | 80 | 48 | 10 |
| WSL 7 | 1:0.4 | 40 | 24 | 10 |
| WSL 8 | 1:1.1 | 80 | 24 | 11 |
| WSL 9 | 1:0.4 | 60 | 48 | 11 |

$$\% Yield = \frac{dry mass of WSL}{dry mass of SKL + WAPMSS} \times 100 \qquad ( S1 )$$

$$\% grafting = ( \frac{\frac{Si}{29} * M w}{100 - \frac{Si}{29} * Mw} ) * 100 \qquad ( S2 )$$

Where Si is the silicon content of copolymers and Mw is the molecular weight of WAPMSS (i.e., 211 g/mol).

TABLE 2
% Organic element and Si from XPS.

| | CHNS | | | | XPS | | | |
|---|---|---|---|---|---|---|---|---|
| Copolymers | N [%] | C [%] | H [%] | S [%] | O [%] | Si [%] | Grafting [%] | Yield [%] |
| SKL | 0 | 62.66 | 5.05 | 29.54 | 19.45 | 0 | N/A | N/A |
| WSL 1 | 3.58 | 49.77 | 5.493 | 1.087 | 21.29 | 6.71 | 59.74 | 72.28 |
| WSL 2 | 3.94 | 43.67 | 5.987 | 0.828 | 22.10 | 12.19 | 108.52 | 76.08 |
| WSL 3 | 2.95 | 44.92 | 6.183 | 1.286 | 21.32 | 11.65 | 103.72 | 68.58 |
| WSL 4 | 3.23 | 44.08 | 6.27 | 1.227 | 24.09 | 14.16 | 126.06 | 70.79 |
| WSL 5 | 3.06 | 46.32 | 5.922 | 0.934 | 23.15 | 13.31 | 118.50 | 71.23 |
| WSL 6 | 2.86 | 44.86 | 6.12 | 1.193 | 24.08 | 14.19 | 126.33 | 76.08 |
| WSL 7 | 1.72 | 53.91 | 6.379 | 1.233 | 24.44 | 6.2 | 55.19 | 60.84 |
| WSL 8 | 2.84 | 51.87 | 6.424 | 1.13 | 22.43 | 11.6 | 103.27 | 72.46 |
| WSL 9 | 2.62 | 50.01 | 6.598 | 1.279 | 22.22 | 9.3 | 82.79 | 73.00 |

Note:
% grafting was calculated using Eq 1 and % yield based on weight.

TABLE 3
Molecular weight (Mw), radius of gyration and hydrodynamic
radius (Hy) of copolymerss and kraft lignin

| Copolymers | MW (g/mol) | R_{g} (nm) | Rₕ (nm) | ~R_{g}/Rₕ |
|---|---|---|---|---|
| SKL | (7.59 ± 0.89) × 10⁴ | 17.1 ± 9.1 | 10 ± 0.002 | 1.7 |
| WSL5 | (1.40 ± 0.18) × 10⁵ | 30.3 ± 17.1 | 20 ± 0.002 | 1.5 |
| WSL6 | (1.80 ± 0.12) × 10⁵ | 36.2 ± 7.41 | 30.4 ± 0.004 | 1.1 |
| WSL2 | (1.14 ± 0.14) × 10⁵ | 17.1 ± 8.1 | 9.6 ± 0.004 | 1.7 |
| WSL10 | (2.14 ± 0.23) × 10⁵ | 58.0 ± 8.4 | 78 ± 0.04 | 0.74 |

± in MW and Rg for standard deviation, relative variance Rₕ

TABLE 4
Coating formulations w/w ratio of WSL 10 to AP binder
and settling rate for three periods of time formulations.

| | | Rate of settling, | | |
|---|---|---|---|---|
| | WSL 10:AP | mm/hr | | |
| Formulation | wt. ratio | 00:30 | 1:00 | 2:00 |
| F1 | 1:0.25 | 50 | 0.6 | 0.5 |
| F2 | 1:0.5 | 22.5 | 2.8 | 0.4 |
| F3 | 1:0.75 | 21.4 | 62.9 | 0.4 |
| F4 | 1:1 | 23.8 | 1.86 | 0.5 |
| F5 | 1:1.25 | 10 | 22 | 32 |
| F6 | 1:1.5 | 15 | 11.7 | 10.8 |
| F7 | 1:1.75 | 15 | 7.7 | 7.6 |
| F8 | 1:2 | 12 | 10 | 9.7 |

Note:
20 g WSL in 1 L water

1. A method of preparing a copolymer comprising:
mixing about 1 part softwood kraft lignin with about 0.4 to about 2.3 parts aminopropyl/methyl silsesquioxane in water at a temperature of below about 80 C at a pH of about 10 to about 12 for at least 24 hours; and
recovering the softwood kraft lignin-aminopropyl/methyl silsequioxane copolymer.

2. The method according to claim 1 wherein the pH of the reaction is about 11.

3. The method according to claim 1 wherein the reaction is carried out under aqueous conditions.

4. The method according to claim 1 wherein the ratio is about 1 to about 1.2 or about 1 to about 1.1.

5. The method according to claim 4 wherein the ratio is 1:1.1 or 1:1.2.

6. The method according to claim 1 wherein the temperature is about 40 C to about 80 C.

7. The method according to claim 1 wherein the temperature is about 60 C.

8. The method according to claim 1 wherein the reaction is carried out for about 24 to about 72 hours.

9. The method according to claim 8 wherein the reaction Is carried out for about 48 hours.

10. Aflame retardant composition comprising about one part softwood kraft lignin-aminopropyl/methyl silsequioxane copolymer according to claim 1 and about 0.25 to 2.0 parts suitable binder.

11. The flame retardant composition according to claim 10 comprising about one part softwood kraft lignin-aminopropyl/methyl silsequioxane copolymer and about one part suitable binder.

12. The flame retardant composition according to claim 10 wherein the binder is selected from the group consisting of a water-soluble inorganic aluminum phosphate binder, a polyurethane binder, and an epoxy binder.

13. A method of preparing a flame retardant composition comprising:
mixing about 1 part softwood kraft lignin with about 0.4 to about 2.3 parts aminopropyl/methyl silsesquioxane in water at a temperature of below about 80 C at a pH of about 10 to about 12 for at least 24 hours;
recovering the softwood kraft lignin-aminopropyl/methyl silsequioxane copolymer; and
mixing about one part copolymer as described above and about 0.25 to 2.0 parts suitable binder, thereby producing the flame retardant composition.

14. The method according to claim 13 wherein the pH of the copolymer reaction is about 11.

15. The method according to claim 13 wherein the ratio is about 1 to about 1.2 or about 1 to about 1.1.

16. The method according to claim 15 wherein the ratio is 1:1.1 or 1:1.2.

17. The method according to claim 13 wherein the temperature is about 40 C to about 80 C.

18. The method according to claim 13 wherein the temperature is about 60 C.

19. The method according to claim 13 wherein the reaction is carried out for about 24 to about 72 hours.

20. The method according to claim 19 wherein the reaction is carried out for about 48 hours.

21. The method according to claim 13 comprising about one part softwood kraft lignin-aminopropyl/methyl silsequioxane copolymer and about one part suitable binder.

22. The method according to claim 13 wherein the binder is selected from the group consisting of a water-soluble inorganic aluminum phosphate binder, a polyurethane binder, and an epoxy binder.
